(19) United States
(12) Patent Application Publication
(10) Pub. No.: US 2022/0334361 A1
(43) Pub. Date: Oct. 20, 2022

(54) Optical Imaging Lens Assembly

(71) Applicant: ZHEJIANG SUNNY OPTICS CO., LTD., Ningbo (CN)

(72) Inventors: Nian CHEN, Ningbo (CN); Haidong XIAO, Ningbo (CN); Xiangxi WU, Ningbo (CN); Wuchao XU, Ningbo (CN); Fujian DAI, Ningbo (CN); Liefeng ZHAO, Ningbo (CN)

(21) Appl. No.: 17/712,081

(22) Filed: Apr. 2, 2022

(30) Foreign Application Priority Data
Apr. 20, 2021 (CN) 202110426999.6

(51) Int. Cl. G02B 13/00; G02B 9/64

(52) U.S. Cl. CPC G02B 13/0045; G02B 9/64

(57) ABSTRACT

The disclosure provides an optical imaging lens assembly, which sequentially includes from an object side to an image side along an optical axis: a variable diaphragm; a first lens; a second lens; a third lens; a fourth lens; a fifth lens, an object-side surface thereof is a convex surface; a sixth lens; and a seventh lens. a center thickness CT1 of the first lens on the optical axis and an air space T67 between the sixth lens and the seventh lens on the optical axis satisfy CT1/T67<1.0. T1 is a distance from the variable diaphragm corresponding to a maximum entrance pupil of the optical imaging lens assembly to an image-side surface of the first lens on the optical axis, FNO1 is an F-number corresponding to the maximum entrance pupil of the optical imaging lens assembly, and T1 and FNO1

### CROSS-REFERENCE TO RELATED APPLICATION

The disclosure claims priority to and the benefit of Chinese Patent Application No. 202110426999.6, filed to the China National Intellectual Property Administration (CHIPA) on 20 Apr. 2021, which is hereby incorporated by reference in its entirety.

### TECHNICAL FIELD

The disclosure relates to the technical field of optical imaging devices, and particularly to an optical imaging lens assembly.

### BACKGROUND

In recent years, with the gradual popularization of intelligent terminals, people's requirements on photographing with mobile phones have increased. A rear camera of each major mainstream flagship mobile phone usually includes an ultra-definition main camera, an ultra-wide-angle lens and a telephoto lens, and is switched in different modes to realize an ultra-definition shooting function. Multiple cameras are matched to implement higher-definition photographing. However, the increase of the number of camer modules makes a larger occupied space of the terminal, which is unfavorable for the development of mobile phones to the trends of miniaturization, light weight and small thickness.

That is, there is such a problem in the related art that an optical imaging lens assembly is poor in imaging quality.

### SUMMARY

A main objective of the disclosure is to provide an optical imaging lens assembly, to solve the problem in the related art that an optical imaging lens assembly is poor in imaging quality.

In order to achieve the above objective, an embodiment of the disclosure provides an optical imaging lens assembly, which sequentially includes from an object side to an image side along an optical axis: a variable diaphragm; a first lens; a second lens; a third lens; a fourth lens; a fifth lens, an object-side surface thereof is a convex surface; a sixth lens; and a seventh lens; wherein a center thickness CT1 of the first lens on the optical axis and an air space T67 between the sixth lens and the seventh lens on the optical axis satisfy CT1/T67<1.0; T1 is a distance from the variable diaphragm corresponding to a maximum entrance pupil of the optical imaging lens assembly to an image-side surface of the first lens on the optical axis, FNO1 is an F-number corresponding to the maximum entrance pupil of the optical imaging lens assembly, and T1 and FNO1 satisfy 0.5<T1/FNO1<1.0.

In an implementation mode, ΔEPD is a difference between a maximum entrance pupil diameter of the optical imaging lens assembly and a minimum entrance pupil diameter of the optical imaging lens assembly, and ΔEPD and an effective focal length f of the optical imaging lens assembly satisfy f/ΔEPD<5.5.

In an implementation mode, TTL is a distance from an object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.5.

In an implementation mode, EPD1 is a maximum entrance pupil diameter of the optical imaging lens assembly, Semi-FOV is a half of a maximum field of view of the optical imaging lens assembly, and EPD1 and Semi-FOV satisfy EPD1*tan(Semi-FOV)<3.0 mm.

In an implementation mode, f1234 is a combined focal length of the first lens, the second lens, the third lens and the fourth lens, f56 is a combined focal length of the fifth lens and the sixth lens, and f1234 and f56 satisfy 0.5<f56/f1234<1.0.

In an implementation mode, Semi-FOV is a half of a maximum field of view of the optical imaging lens assembly, and Semi-FOV and an effective focal length f of the optical imaging lens assembly satisfy f*tan(Semi-FOV)>4.5 mm.

In an implementation mode, a center thickness CT4 of the fourth lens on the optical axis and an air space T23 between the second lens and the third lens on the optical axis satisfy 0.5<CT4/T23<1.0.

In an implementation mode, SAG61 is an on-axis distance from an intersection point of an object-side surface of the sixth lens and the optical axis to an effective radius vertex of the object-side surface of the sixth lens, SAG62 is an on-axis distance from an intersection point of an image-side surface of the sixth lens and the optical axis to an effective radius vertex of the image-side surface of the sixth lens, and SAG61 and SAG62 satisfy 0<SAG61/SAG62<1.0.

In an implementation mode, SAG71 is an on-axis distance from an intersection point of an object-side surface of the seventh lens and the optical axis to an effective radius vertex of the object-side surface of the seventh lens, SAG72 is an on-axis distance from an intersection point of an image-side surface of the seventh lens and the optical axis to an effective radius vertex of the image-side surface of the seventh lens, and SAG71 and SAG72 satisfy 0<SAG72/SAG71<1.0.

In an implementation mode, an effective focal length f2 of the second lens, an effective focal length f6 of the sixth lens and an effective focal length f7 of the seventh lens satisfy 0.3<f6/(f7−f2)<1.3.

In an implementation mode, an effective focal length f1 of the first lens, a curvature radius R1 of an object-side surface of the first lens and a curvature radius R2 of an image-side surface of the first lens satisfy 0<f1/(R2−R1)<1.0.

In an implementation mode, a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy 0<(R3+R4)/(R5+R6)<1.0.

In an implementation mode, the second lens has a negative refractive power; an image-side surface of the third lens is a concave surface; the fourth lens has a positive refractive power; the fifth lens has a positive refractive power; the sixth lens has a positive refractive power.

Another embodiment of the disclosure provides an optical imaging lens assembly, which sequentially includes from an object side to an image side along an optical axis: a variable diaphragm; a first lens; a second lens; a third lens; a fourth lens; a fifth lens, an object-side surface thereof is a convex surface; a sixth lens; and a seventh lens; wherein a center thickness CT1 of the first lens on the optical axis and an air space T67 between the sixth lens and the seventh lens on the optical axis satisfy CT1/T67<1.0; EPD1 is a maximum entrance pupil diameter of the optical imaging lens assembly, Semi-FOV is a half of a maximum field of view of the optical imaging lens assembly, and EPD1 and Semi-FOV satisfy EPD1×tan(Semi-FOV)<3.0 mm.

In an implementation mode, ΔEPD is a difference between the maximum entrance pupil diameter of the optical imaging lens assembly and a minimum entrance pupil diameter of the optical imaging lens assembly, and ΔEPD and an effective focal length f of the optical imaging lens assembly satisfy f/ΔEPD<5.5.

In an implementation mode, TTL is a distance from an object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.5.

In an implementation mode, f1234 is a combined focal length of the first lens, the second lens, the third lens and the fourth lens, f56 is a combined focal length of the fifth lens and the sixth lens, and f1234 and f56 satisfy 0.5<f56/f1234<1.0.

In an implementation mode, Semi-FOV is a half of the maximum field of view of the optical imaging lens assembly, and Semi-FOV and an effective focal length f of the optical imaging lens assembly satisfy f*tan(Semi-FOV)>4.5 mm.

In an implementation mode, a center thickness CT4 of the fourth lens on the optical axis and an air space T23 between the second lens and the third lens on the optical axis satisfy 0.5<CT4/T23<1.0.

In an implementation mode, SAG61 is an on-axis distance from an intersection point of an object-side surface of the sixth lens and the optical axis to an effective radius vertex of the object-side surface of the sixth lens, SAG62 is an on-axis distance from an intersection point of an image-side surface of the sixth lens and the optical axis to an effective radius vertex of the image-side surface of the sixth lens, and SAG61 and SAG62 satisfy 0<SAG61/SAG62<1.0.

In an implementation mode, SAG71 is an on-axis distance from an intersection point of an object-side surface of the seventh lens and the optical axis to an effective radius vertex of the object-side surface of the seventh lens, SAG72 is an on-axis distance from an intersection point of an image-side surface of the seventh lens and the optical axis to an effective radius vertex of the image-side surface of the seventh lens, and SAG71 and SAG72 satisfy 0<SAG72/SAG71<1.0.

In an implementation mode, an effective focal length f2 of the second lens, an effective focal length f6 of the sixth lens and an effective focal length f7 of the seventh lens satisfy 0.3<f6/(f7−f2)<1.3.

In an implementation mode, an effective focal length f1 of the first lens, a curvature radius R1 of an object-side surface of the first lens and a curvature radius R2 of an image-side surface of the first lens satisfy 0<f1(R1−R1)<1.0.

In an implementation mode, a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy 0<(R3+R4)/(R5+R6)<1.0.

In an implementation mode, the second lens has a negative refractive power; an image-side surface of the third lens is a concave surface; the fourth lens has a positive refractive power; the fifth lens has a positive refractive power; the sixth lens has a positive refractive power.

With the application of the technical solutions of the disclosure, an optical imaging lens assembly sequentially includes from an object side to an image side along an optical axis: a variable diaphragm; a first lens; a second lens; a third lens; a fourth lens; a fifth lens; a sixth lens; and a seventh lens; an object-side surface of the fifth lens is a convex surface; wherein a center thickness CT1 of the first lens on the optical axis and an air space T67 between the sixth lens and the seventh lens on the optical axis satisfy CT1/T67<1.0; T1 is a distance from the variable diaphragm corresponding to a maximum entrance pupil of the optical imaging lens assembly to an image-side surface of the first lens on the optical axis, FNO1 is an F-number corresponding to the maximum entrance pupil of the optical imaging lens assembly, and T1 and FNO1 satisfy 0.5<T1 /FNO1<1.0.

The object-side surface of the fifth lens is arranged to be a convex surface, so that a machinability of a surface type of the fifth lens and a structural strength of the fifth lens are further ensured. A ratio of the center thickness CT1 of the first lens on the optical axis to the air space T67 between the sixth lens and the seventh lens on the optical axis is restricted to be smaller than 1, so that a thickness of the whole optical imaging lens assembly may be kept within a reasonable machining range, each lens is distributed uniformly, and the structure is compact. A ratio of the distance T1 from the variable diaphragm corresponding to the maximum entrance pupil of the optical imaging lens assembly to the image-side surface of the first lens on the optical axis to the F-number FNO1 corresponding to the maximum entrance pupil of the optical imaging lens assembly is restricted to range from 0.5 to 1, so that a large luminous flux of the whole optical imaging lens assembly may be ensured, and furthermore, the imaging quality and imaging stability of the optical imaging lens assembly are ensured.

### BRIEF DESCRIPTION OF THE DRAWINGS

The drawings forming a part of the disclosure in the specification are adopted to provide a further understanding to the disclosure. Schematic embodiments of the disclosure and descriptions thereof are adopted to explain the disclosure and not intended to form improper limits to the disclosure. In the drawings:

FIG. 1 shows a structural schematic diagram of an optical imaging lens assembly at a maximum entrance pupil according to Example 1 of the disclosure;

FIGS. 2-4 show a longitudinal aberration curve, an astigmatism curve and a distortion curve of the optical imaging lens assembly in FIG. 1 respectively;

FIG. 5 shows a structural schematic diagram of an optical imaging lens assembly at a minimum entrance pupil according to Example 1 of the disclosure;

FIGS. 6-8 show a longitudinal aberration curve, an astigmatism curve and a distortion curve of the optical imaging lens assembly in FIG. 2 respectively;

FIG. 9 shows a structural schematic diagram of an optical imaging lens assembly at a maximum entrance pupil according to Example 2 of the disclosure;

FIGS. 10-12 show a longitudinal aberration curve, an astigmatism curve and a distortion curve of the optical imaging lens assembly in FIG. 9 respectively;

FIG. 13 shows a structural schematic diagram of an optical imaging lens assembly at a minimum entrance pupil according to Example 2 of the disclosure;

FIGS. 14-16 show a longitudinal aberration curve, an astigmatism curve and a distortion curve of the optical imaging lens assembly in FIG. 13 respectively;

FIG. 17 shows a structural schematic diagram of an optical imaging lens assembly at a maximum entrance pupil according to Example 3 of the disclosure;

FIGS. 18-20 show a longitudinal aberration curve, an astigmatism curve and a distortion curve of the optical imaging lens assembly in FIG. 17 respectively;

FIG. 21 shows a structural schematic diagram of an optical imaging lens assembly at a minimum entrance pupil according to Example 3 of the disclosure;

FIGS. 22-24 show a longitudinal aberration curve, an astigmatism curve and a distortion curve of the optical imaging lens assembly in FIG. 21 respectively;

FIG. 25 shows a structural schematic diagram of an optical imaging lens assembly at a maximum entrance pupil according to Example 4 of the disclosure;

FIGS. 26-28 show a longitudinal aberration curve, an astigmatism curve and a distortion curve of the optical imaging lens assembly in FIG. 25 respectively;

FIG. 29 shows a structural schematic diagram of an optical imaging lens assembly at a minimum entrance pupil according to Example 4 of the disclosure;

FIGS. 30-32 show a longitudinal aberration curve, an astigmatism curve and a distortion curve of the optical imaging lens assembly in FIG. 29 respectively;

FIG. 33 shows a structural schematic diagram of an optical imaging lens assembly at a maximum entrance pupil according to Example 5 of the disclosure;

FIGS. 34-36 show a longitudinal aberration curve, an astigmatism curve and a distortion curve of the optical imaging lens assembly in FIG. 33 respectively;

FIG. 37 shows a structural schematic diagram of an optical imaging lens assembly at a minimum entrance pupil according to Example 5 of the disclosure;

FIGS. 38-40 show a longitudinal aberration curve, an astigmatism curve and a distortion curve of the optical imaging lens assembly in FIG. 37 respectively;

FIG. 41 shows a structural schematic diagram of an optical imaging lens assembly at a maximum entrance pupil according to Example 6 of the disclosure;

FIGS. 42-44 show a longitudinal aberration curve, an astigmatism curve and a distortion curve of the optical imaging lens assembly in FIG. 41 respectively;

FIG. 45 shows a structural schematic diagram of an optical imaging lens assembly at a minimum entrance pupil according to Example 6 of the disclosure; and

FIGS. 46-48 show a longitudinal aberration curve, an astigmatism curve and a distortion curve of the optical imaging lens assembly in FIG. 45 respectively.

The drawings include the following reference signs:

STO: a variable diaphragm; E1: a first lens; S1: an object-side surface of the first lens; S2: an image-side surface of the first lens; E2: a second lens; S3: an object-side surface of the second lens; S4: an image-side surface of the second lens; E3: a third lens; S5: an object-side surface of the third lens; S6: an image-side surface of the third lens; E4: a fourth lens; S7: an object-side surface of the fourth lens; S8: an image-side surface of the fourth lens; E5: a fifth lens; S9: an object-side surface of the fifth lens; S10: an image-side surface of the fifth lens; E6: a sixth lens; S11: an object-side surface of the sixth lens; S12: an image-side surface of the sixth lens; E7: a seventh lens; S13: an object-side surface of the seventh lens; S14: an image-side surface of the seventh lens; E8: an optical filter; S15: an object-side surface of the optical filter; S16: an image-side surface of the optical filter; and S17: an imaging surface.

### DETAILED DESCRIPTION OF THE EMBODIMENTS

It is to be noted that the embodiments in the disclosure and features in the embodiments may be combined without conflicts. The disclosure will be described below with reference to the drawings and in combination with the embodiments in detail.

It is to be pointed out that, unless otherwise specified, all technical and scientific terms used in the disclosure have the same meanings as commonly understood by those of ordinary skill in the art of the disclosure.

In the disclosure, unless conversely specified, the used orientation terms “upper, lower, top, and bottom” are usually for the directions shown in the drawings, or for a component in a vertical, perpendicular, or gravity direction. Similarly, for convenient understanding and description, “inner and outer” refer to inner and outer relative to a contour of each component. However, these orientation terms are not intended to limit the disclosure.

It should be noted that, in this description, expressions first, second, third and the like are only used to distinguish one feature from another feature and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, close to an object side, of each lens is called an object-side surface of the lens, and a surface, close to an image side, of each lens is called an image-side surface of the lens. A surface type of the paraxial region may be judged according to a judgment manner known to those of ordinary skill in the art, and whether a surface is concave or convex is judged according to whether an R value is positive or negative (R refers to a curvature radius of the paraxial region, usually refers to an R value on lens data in optical software). For example, an object-side surface is determined as a convex surface if the R value is positive, and is determined as a concave surface if the R value is negative. An image-side surface is determined as a concave surface if the R value is positive, and is determined as a convex surface is the R value is negative.

In order to solve the problem in the related art that an optical imaging lens assembly is poor in imaging quality, the disclosure provides an optical imaging lens assembly.

### Embodiment 1

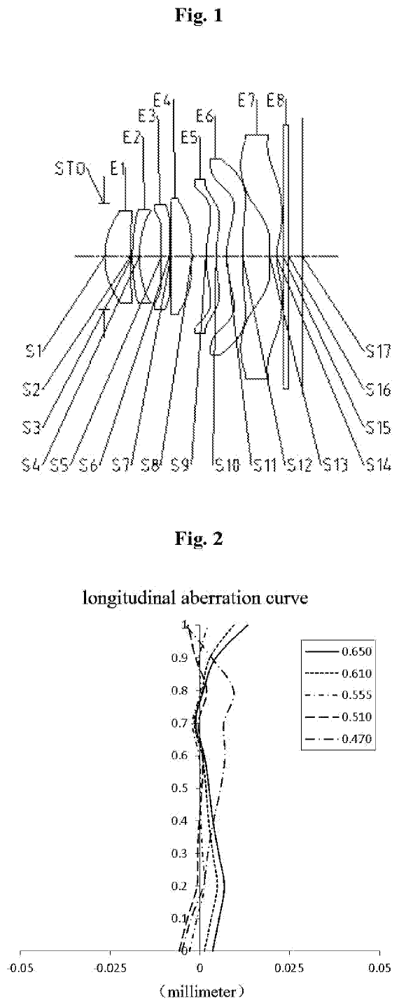

As shown in FIGS. 1 to 48, an optical imaging lens assembly sequentially includes from an object side to an image side along an optical axis: a variable diaphragm; a first lens; a second lens; a third lens; a fourth lens; a fifth lens; a sixth lens; and a seventh lens; an object-side surface of the fifth lens is a convex surface; a center thickness CT1 of the first lens on the optical axis and an air space T67 between the sixth lens and the seventh lens on the optical axis satisfy CT1/T67<1.0; T1 is a distance from the variable diaphragm corresponding to a maximum entrance pupil of the optical imaging lens assembly to an image-side surface of the first lens on the optical axis, FNO1 is an F-number corresponding to the maximum entrance pupil of the optical imaging lens assembly, and T1 and FNO1 satisfy 0.5<T1/FNO1<1.0.

The object-side surface of the fifth lens is arranged to be a convex surface, so that a machinability of a surface type of the fifth lens and a structural strength of the fifth lens are further ensured. A ratio of the center thickness CT1 of the first lens on the optical axis to the air space T67 between the sixth lens and the seventh lens on the optical axis is restricted to be smaller than 1, so that a thickness of the whole optical imaging lens assembly may be kept within a reasonable machining range, each lens is distributed uniformly, and the structure is compact. A ratio of the distance T1 from the variable diaphragm corresponding to the maximum entrance pupil of the optical imaging lens assembly to the image-side surface of the first lens on the optical axis to the F-number corresponding to the maximum entrance pupil of the optical imaging lens assembly is restricted to range from 0.5 to 1, so that a large luminous flux of the whole optical imaging lens assembly may be ensured, and furthermore, the imaging quality and imaging stability of the optical imaging lens assembly are ensured.

More specifically, the center thickness CT1 of the first lens on the optical axis and the air space T67 between the sixth lens and the seventh lens on the optical axis satisfy 0.69≤CT1/T67≤0.95. The distance T1 from the variable diaphragm corresponding to the maximum entrance pupil of the optical imaging lens assembly to the image-side surface of the first lens on the optical axis and the F-number FNO1 corresponding to the maximum entrance pupil of the optical imaging lens assembly satisfy 0.6<T1/FNO1<0.85.

In the embodiment, ΔEPD is a difference between a maximum entrance pupil diameter of the optical imaging lens assembly and a minimum entrance pupil diameter of the optical imaging lens assembly, and ΔEPD and an effective focal length f of the optical imaging lens assembly satisfy f/ΔEPD<5.5. A ratio of the effective focal length f of the lens assembly to the difference ΔEPD between the maximum entrance pupil diameter and the minimum entrance pupil diameter is restricted within a reasonable range, so that a luminous flux of the optical imaging lens assembly may be kept within a proper range to ensure high imaging quality of the optical imaging lens assembly. More specifically, the effective focal length f of the optical imaging lens assembly and the difference ΔEPD between the maximum entrance pupil diameter of the optical imaging lens assembly and the minimum entrance pupil diameter of the optical imaging lens assembly satisfy 4.9<f/ΔEPD<5.1.

In the embodiment, TTL is a distance from an object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.5. Such a setting is favorable for arranging the lenses in the optical imaging lens assembly more compactly, which contributes to miniaturizing the optical imaging lens assembly. More specifically, 1.4<TTL/ImgH<1.5.

In the embodiment, EPD1 is a maximum entrance pupil diameter of the optical imaging lens assembly, Semi-FOV is a half of a maximum field of view of the optical imaging lens assembly, and EPD1 and Semi-FOV satisfy EPD1*tan(Semi-FOV)<3.0 mm. A relationship between the maximum entrance pupil diameter and the maximum field of view of the optical imaging lens assembly is restricted, so that a size of a field of view of the optical imaging lens assembly may be ensured, and the imaging quality may be ensured. More specifically, 2.3 mm<EPD1*tan(Semi-FOV)<2.5 mm.

In the embodiment, f1234 is a combined focal length of the first lens, the second lens, the third lens and the fourth lens, f56 is a combined focal length of the fifth lens and the sixth lens, and f1234 and f56 satisfy 0.5<f56/f1234<1.0. A ratio of the combined focal length of the fifth lens and the sixth lens to the combined focal length of the first lens, the second lens, the third lens and the fourth lens is restricted within a reasonable range, so that the reasonable distribution of a refractive power of each lens is ensured, and a small aberration of the optical imaging lens assembly is facilitated. More specifically, 0.7<f56/f1234<0.9.

In the embodiment, Semi-FOV is a half of the maximum field of view of the optical imaging lens assembly, and f and Semi-FOV and an effective focal length f of the optical imaging lens assembly satisfy f*tan(Semi-FOV)>4.5 mm. Such a setting enables the optical imaging lens assembly to implement imaging within a large image surface range. More specifically, 4.8 mm<f*tan(Semi-FOV)<5.1 mm.

In the embodiment, a center thickness CT4 of the fourth lens on the optical axis and an air T23 space between the second lens and the third lens on the optical axis satisfy 0.5<CT4/T23<1.0. Such a setting ensures the more uniform distribution of the lenses in the optical imaging lens assembly and a more reasonable thickness of the fourth lens to facilitate the machining the optical imaging lens assembly, and may reduce a total length of the optical imaging lens assembly to facilitate the miniaturization of the optical imaging lens assembly. More specifically, 0.7<CT4/T23<1.0.

In the embodiment, SAG61 is an on-axis distance from an intersection point of an object-side surface of the sixth lens and the optical axis to an effective radius vertex of the object-side surface of the sixth lens, SAG62 is an on-axis distance from an intersection point of an image-side surface of the sixth lens and the optical axis to an effective radius vertex of the image-side surface of the sixth lens, and SAG61 and SAG62 satisfy 0<SAG61/SAG62<1.0. Such a setting may reduce the bending of the sixth lens as well as difficulties in the machining and imaging of the sixth lens to facilitate the manufacturing of the sixth lens, and may reduce the risk of deformation of the sixth lens. More specifically, 0.4<SAG61/SAG62<1.0.

In the embodiment, SAG71 is an on-axis distance from an intersection point of an object-side surface of the seventh lens and the optical axis to an effective radius vertex of the object-side surface of the seventh lens, SAG72 is an on-axis distance from an intersection point of an image-side surface of the seventh lens and the optical axis to an effective radius vertex of the image-side surface of the seventh lens, and SAG71 and SAG72 satisfy 0<SAG72/SAG71<1.0. Such a setting may reduce the bending of the seventh lens as well as difficulties in the machining and imaging of the seventh lens to facilitate the manufacturing of the seventh lens, and may reduce the risk of deformation of the seventh lens. More specifically, 0.3<SAG72/SAG71<0.8.

In the embodiment, an effective focal length f2 of the second lens, an effective focal length f6 of the sixth lens and an effective focal length f7 of the seventh lens satisfy 0.3<f6/(f7−f2)<1.3. Such a setting is favorable for configuring the refractive power of the optical imaging lens assembly reasonably and reducing the tolerance sensitivity of each lens. More specifically, 0.4<f6/(f7−f2)<1.1.

In the embodiment, an effective focal length f1 of the first lens, a curvature radius R1 of an object-side surface of the first lens and a curvature radius R2 of an image-side surface of the first lens satisfy 0<f1/(R2−R1)<1.0. Such a setting may restrict the curvature radius of the first lens within a reasonable range to optimize an aberration contribution of the first lens and reduce an aberration of the optical imaging lens assembly. More specifically, 0.05<f1/(R2−R1)<0.8.

In the embodiment, a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy 0<(R3+R4)/(R5+R6)<1.0. Such a setting may adjust aberration contributions of the second lens and the third lens to reduce an aberration of the optical imaging lens assembly. More specifically, 0.2<(R3+R4)/(R5+R6)<0.6.

In the embodiment, the second lens has a negative refractive power; an image-side surface of the third lens is a concave surface; the fourth lens has a positive refractive power; the fifth lens has a positive refractive power; the sixth lens has a positive refractive power. The surface type and refractive power of each lens are configured reasonably, so that the tolerance sensitivity of each lens is reduced, an aberration of the optical imaging lens assembly is reduced, and relatively high imaging quality of the optical imaging lens assembly is ensured.

### Embodiment 2

As shown in FIGS. 1-48, an optical imaging lens assembly sequentially includes from an object side to an image side along an optical axis: a variable diaphragm; a first lens; a second lens; a third lens; a fourth lens; a fifth lens, an object-side surface thereof is a convex surface; a sixth lens; and a seventh lens; wherein a center thickness CT1 of the first lens on the optical axis and an air space T67 between the sixth lens and the seventh lens on the optical axis satisfy CT1/T67<1.0; EPD1 is a maximum entrance pupil diameter of the optical imaging lens assembly, Semi-FOV is a half of a maximum field of view of the optical imaging lens assembly, and EPD1 and Semi-FOV satisfy EPD1×tan(Semi-FOV)<3.0 mm.

The object-side surface of the fifth lens is arranged to be a convex surface, so that a machinability of a surface type of the fifth lens and a structural strength of the fifth lens are further ensured. A ratio of the center thickness CT1 of the first lens on the optical axis to the air space T67 between the sixth lens and the seventh lens on the optical axis is restricted to be smaller than 1, so that a thickness of the whole optical imaging lens assembly may be kept within a reasonable machining range, each lens is distributed uniformly, and the structure is compact. A relationship between the maximum entrance pupil diameter and maximum field of view of the optical imaging lens assembly is restricted, so that a size of a field of view of the optical imaging lens assembly may be ensured, and the imaging quality may be ensured.

More specifically, the center thickness CT1 of the first lens on the optical axis and the air space T67 between the sixth lens and the seventh lens on the optical axis satisfy 0.69≤CT1/T67≤0.95. The maximum entrance pupil diameter EPD1 of the optical imaging lens assembly and a half Semi-FOV of the maximum field of view of the optical imaging lens assembly satisfy 2.3 mm<EPD1*tan(Semi-FOV)<2.5 mm.

In the embodiment, ΔEPD is a difference between the maximum entrance pupil diameter of the optical imaging lens assembly and a minimum entrance pupil diameter of the optical imaging lens assembly, and ΔEPD and an effective focal length f of the optical imaging lens assembly satisfy f/ΔEPD<5.5. A ratio of the effective focal length f of the lens assembly to the difference ΔEPD between the maximum entrance pupil diameter and the minimum entrance pupil diameter is restricted within a reasonable range, so that a luminous flux of the optical imaging lens assembly may be kept within a proper range to ensure high imaging quality of the optical imaging lens assembly. More specifically, 4.9<f/ΔEPD<5.1.

In the embodiment, TTL is a distance from an object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.5. Such a setting is favorable for arranging the lenses in the optical imaging lens assembly more compactly, which contributes to miniaturizing the optical imaging lens assembly. More specifically, 1.4<TTL/ImgH<1.5.

In the embodiment, f1234 is a combined focal length of the first lens, the second lens, the third lens and the fourth lens, f56 is a combined focal length of the fifth lens and the sixth lens, and f1234 and f56 satisfy 0.5<f56/f1234<1.0. A ratio of the combined focal length of the fifth lens and the sixth lens to the combined focal length of the first lens, the second lens, the third lens and the fourth lens is restricted within a reasonable range, so that the reasonable distribution of a refractive power of each lens is ensured, and an small aberration of the optical imaging lens assembly is facilitated. More specifically, 0.7<f56/f1234<0.9.

In the embodiment, Semi-FOV is a half of the maximum field of view of the optical imaging lens assembly, and Semi-FOV and an effective focal length f of the optical imaging lens assembly satisfy f*tan(Semi-FOV)>4.5 mm. Such a setting enables the optical imaging lens assembly to implement imaging within a large image surface range. More specifically, 4.8 mm<f*tan(Semi-FOV)<5.1 mm.

In the embodiment, a center thickness CT4 of the fourth lens on the optical axis and an air space T23 between the second lens and the third lens on the optical axis satisfy 0.5<CT4/T23<1.0. Such a setting ensures the more uniform distribution of the lenses in the optical imaging lens assembly and a more reasonable thickness of the fourth lens to facilitate the machining the optical imaging lens assembly, and may reduce a total length of the optical imaging lens assembly to facilitate the miniaturization of the optical imaging lens assembly. More specifically, 0.7<CT4/T23<1.0.

In the embodiment, SAG61 is an on-axis distance from an intersection point of an object-side surface of the sixth lens and the optical axis to an effective radius vertex of the object-side surface of the sixth lens, SAG62 is an on-axis distance from an intersection point of an image-side surface of the sixth lens and the optical axis to an effective radius vertex of the image-side surface of the sixth lens, and SAG61 and SAG62 satisfy 0<SAG61/SAG62<1.0. Such a setting may reduce the bending of the sixth lens as well as difficulties in the machining and imaging of the sixth lens to facilitate the manufacturing of the sixth lens, and may reduce the risk of deformation of the sixth lens. More specifically, 0.4<SAG61/SAG62<1.0.

In the embodiment, SAG71 is an on-axis distance from an intersection point of an object-side surface of the seventh lens and the optical axis to an effective radius vertex of the object-side surface of the seventh lens, SAG72 is an on-axis distance from an intersection point of an image-side surface of the seventh lens and the optical axis to an effective radius vertex of the image-side surface of the seventh lens, and SAG71 and SAG72 satisfy 0<SAG72/SAG71<1.0. Such a setting may reduce the bending of the seventh lens as well as difficulties in the machining and imaging of the seventh lens to facilitate the manufacturing of the seventh lens, and may reduce the risk of deformation of the seventh lens. More specifically, 0.3<SAG72/SAG71<0.8.

In the embodiment, an effective focal length f2 of the second lens, an effective focal length f6 of the sixth lens and an effective focal length f7 of the seventh lens satisfy 0.3<f6/(f7−f2)<1.3. Such a setting is favorable for configuring the refractive power of the optical imaging lens assembly reasonably and reducing the tolerance sensitivity of each lens. More specifically, 0.4<f6/(f7−f2)<1.1.

In the embodiment, an effective focal length f1 of the first lens, a curvature radius R1 of an object-side surface of the first lens and a curvature radius R2 of an image-side surface of the first lens satisfy 0<f1/(R2−R1)<1.0. Such a setting may restrict the curvature radius of the first lens within a reasonable range to optimize an aberration contribution of the first lens and reduce an aberration of the optical imaging lens assembly. More specifically, 0.05<f1/(R2−R1)<0.8.

In the embodiment, a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy 0<(R3+R4)/(R5+R6)<1.0. Such a setting may adjust aberration contributions of the second lens and the third lens to reduce an aberration of the optical imaging lens assembly. More specifically, 0.2<(R3+R4)/(R5+R6)<0.6.

In the embodiment, the second lens has a negative refractive power; an image-side surface of the third lens is a concave surface; the fourth lens has a positive refractive power; the fifth lens has a positive refractive power; the sixth lens has a positive refractive power. The surface type and refractive power of each lens are configured reasonably, so that the tolerance sensitivity of each lens is reduced, an aberration of the optical imaging lens assembly is reduced, and relatively high imaging quality of the optical imaging lens assembly is ensured.

In an embodiment, the optical imaging lens assembly may further include an optical filter configured to correct the chromatic aberration and/or a protective glass configured to protect a photosensitive element on the imaging surface.

The optical imaging lens assembly in the disclosure may adopt multiple lenses, for example, the abovementioned seven. The refractive power and the surface types of each lens, the center thicknesses of each lens, on-axis distances between the lenses and the like may be reasonably configured to effectively enlarge an aperture of the optical imaging lens assembly, reduce the sensitivity of the lens assembly, improve the machinability of the lens assembly, and ensure that the optical imaging lens assembly is more favorable for production and machining and applicable to a portable electronic device. The optical imaging lens assembly also has the advantages of large aperture, large field of view, ultra-thin design and high imaging quality, and may satisfy a miniaturization requirement of an intelligent electronic product.

In the disclosure, at least one of mirror surfaces of the lenses is an aspheric mirror surface. An aspheric lens has a feature that a curvature keeps changing from a center of the lens to a periphery of the lens. Unlike a spherical lens with a constant curvature from a center of the lens to a periphery of the lens, the aspheric lens has a better curvature radius feature and the advantages of improving distortions and improving astigmatism aberrations. With the adoption of the aspheric lens, astigmatism aberrations during imaging may be eliminated as much as possible, thereby improving the imaging quality.

However, those skilled in the art should know that the number of the lenses forming the optical imaging lens assembly may be changed without departing from the technical solutions claimed in the disclosure to achieve each result and advantage described in the specification. For example, although descriptions are made in the embodiment with seven lenses as an example, the optical imaging lens assembly is not limited to seven lenses. If necessary, the optical imaging lens assembly may include another number of lenses.

Examples of specific surface types and parameters applied to the optical imaging lens assembly of the above-mentioned embodiment will further be described below with reference to the drawings.

It is to be noted that any one of following Example 1 to Example 6 is applied to all embodiments of the disclosure.

### EXAMPLE 1

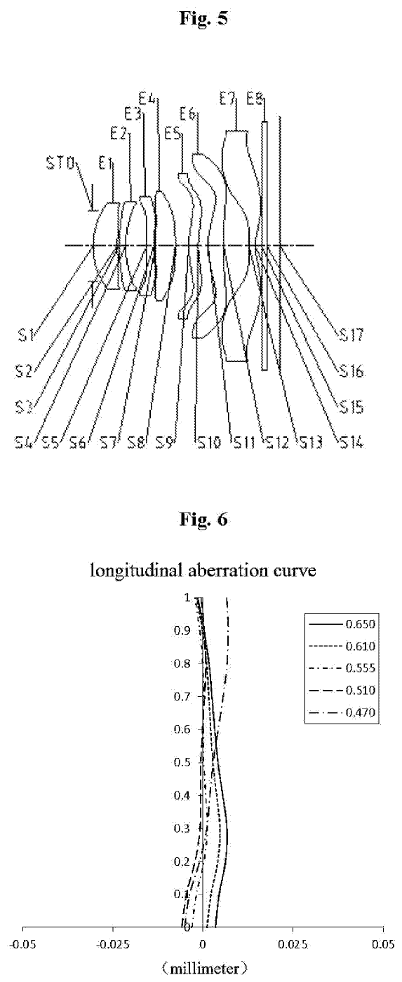

As shown in FIGS. 1-8, an optical imaging lens assembly according to Example 1 of the disclosure is described. FIG. 1 shows a structural schematic diagram of the optical imaging lens assembly at a maximum entrance pupil according to Example 1. FIG. 5 shows a structural schematic diagram of the optical imaging lens assembly at a minimum entrance pupil according to Example 1.

As shown in FIGS. 1 and 5, the optical imaging lens assembly sequentially includes from an object side to an image side: a variable diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a negative refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a convex surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a convex surface. The seventh lens E7 has a negative refractive power, an object-side surface S13 of the seventh lens is a convex surface, and an image-side surface S14 of the seventh lens is a concave surface. The optical filter E8 has an object-side surface S15 of the optical filter and an image-side surface S16 of the optical filter. Light from an object sequentially penetrates through each of the surfaces S1 to S16, and is finally imaged on the imaging surface S17.

In the example, f is a total effective focal length of the optical imaging lens assembly, and f is 5.66 mm. FOV is a maximum field of view of the optical imaging lens assembly, and FOV is 41.5°. In the example, TTL is 7.39. FNO2 is an F-number corresponding to a minimum entrance pupil of the optical imaging lens assembly, and FNO2 is 2.05. FNO1 is an F-number corresponding to a maximum entrance pupil of the optical imaging lens assembly, and FNO1 is 1.45.

Table 1 shows a basic structural parameter table of the optical imaging lens assembly of Example 1, wherein the units of the curvature radius, the thickness/distance, and the focal length are all millimeters (mm).

TABLE 1

| | | | | Material | | |
|---|---|---|---|---|---|---|
| | | | | Refrac- | | Conic |
| Surface | Surface | Curvature | Thick- | tive | Abbe | coef- |
| number | type | radius | ness | index | number | ficient |
| OBJ | Spherical | Infinite | Infinite | | | |
| STO | Spherical | Infinite | 0.0066 | | | |
| S1 | Aspheric | 2.9063 | 0.9565 | 1.55 | 56.1 | 0.0315 |
| S2 | Aspheric | 13.9135 | 0.0724 | | | 9.8062 |
| S3 | Aspheric | 5.0954 | 0.2647 | 1.67 | 19.2 | −0.4525 |
| S4 | Aspheric | 3.5451 | 0.8290 | | | 0.0231 |
| S5 | Aspheric | 17.5433 | 0.2886 | 1.67 | 20.3 | 42.2961 |
| S6 | Aspheric | 5.8071 | 0.0584 | | | −0.5971 |
| S7 | Aspheric | 8.3485 | 0.7920 | 1.55 | 56.1 | −3.5327 |
| S8 | Aspheric | −20.4476 | 0.5233 | | | 64.6353 |
| S9 | Aspheric | 3.2725 | 0.3747 | 1.57 | 38.0 | 0.0622 |
| S10 | Aspheric | 3.2706 | 0.3917 | | | −0.0081 |
| S11 | Aspheric | 3.4033 | 0.6085 | 1.55 | 56.1 | 0.0002 |
| S12 | Aspheric | −62.5000 | 1.0074 | | | −26.3210 |
| S13 | Aspheric | 7.4718 | 0.2553 | 1.54 | 55.9 | 0.5506 |
| S14 | Aspheric | 1.7171 | 0.2489 | | | −0.9808 |
| S15 | Spherical | Infinite | 0.2100 | 1.52 | 64.2 | |
| S16 | Spherical | Infinite | 0.5128 | | | |
| S17 | Spherical | Infinite | | | | |

In Example 1, both the object-side surface and the image-side surface of any lens in the first lens E1 to the seventh lens E7 are aspheric surfaces. A surface type of each aspheric lens may be defined through, but not limited to, the following aspheric surface formula:

$$x = \frac{c {h}^{2}}{1 + \sqrt{1 - ( k + 1 ) {c}^{2} {h}^{2}}} + \sum A i {h}^{i} \qquad Formula ( 1 )$$

wherein x is a vector height of a distance between the aspheric surface and a vertex of the aspheric surface when the aspheric surface is located at a position with the height h in an optical axis direction; c is a paraxial curvature of the aspheric surface, c=1/R (namely, the paraxial curvature c is a reciprocal of the curvature radius R in Table 1 above); k is a conic coefficient; and Ai is a correction coefficient of the i-th order of the aspheric surface. Table 2 shows high-order coefficients A4, A6, A8, A10, A12, A14, A16, A18, A20, A22, A24, A26, A28 and A30 that may be used for each of the aspheric mirror surfaces S1 to S14 in Example 1.

TABLE 2

| Surface number | A4 | A6 | A8 | A10 | A12 | A14 | A16 |
|---|---|---|---|---|---|---|---|
| S1 | 2.8028E−04 | −8.5150E−03 | −4.3924E−03 | −1.7909E−03 | −8.2209E−04 | −4.3475E−04 | −2.1173E−04 |
| S2 | −8.0355E−02 | 1.0535E−02 | −8.2657E−03 | −3.1669E−04 | −1.9579E−03 | −7.0899E−05 | −7.1482E−05 |
| S3 | −1.1605E−01 | 5.2484E−02 | −2.3878E−03 | 9.7421E−04 | −1.9593E−03 | −1.8076E−04 | −7.5249E−05 |
| S4 | −3.3631E−02 | 5.1013E−02 | 9.4258E−03 | 3.1687E−03 | −4.8628E−04 | −4.5433E−04 | −2.2210E−04 |
| S5 | −4.0922E−01 | −1.1467E−02 | 9.9414E−03 | 4.7260E−03 | −8.3094E−04 | −1.0168E−03 | −6.8282E−04 |
| S6 | −4.9190E−01 | 3.0396E−02 | 3.3524E−03 | 4.8038E−03 | −2.6430E−03 | −8.6123E−05 | −8.4417E−04 |
| S7 | −3.0051E−01 | 6.9470E−02 | −3.8184E−03 | 5.5692E−03 | −4.9542E−04 | 1.1408E−03 | −8.8585E−04 |
| S8 | −4.6920E−01 | 7.4169E−02 | 1.7360E−02 | 1.4212E−02 | 8.4020E−03 | 3.6033E−03 | −6.5117E−04 |
| S9 | −1.7540E+00 | −2.1487E−02 | 1.0180E−02 | 2.6197E−02 | −9.7283E−04 | 4.2296E−03 | 2.2843E−04 |
| S10 | −2.4356E+00 | 3.0472E−01 | 4.0219E−02 | −6.0235E−03 | −3.0813E−02 | 3.5394E−03 | 4.6679E−03 |
| S11 | −3.2080E+00 | 3.4625E−02 | 1.7223E−01 | −3.9180E−02 | −4.8774E−02 | −9.6919E−03 | 1.1008E−02 |
| S12 | −4.3352E−01 | −3.8214E−01 | 1.3300E−01 | −2.8276E−02 | 1.9816E−02 | −4.5782E−03 | 8.7702E−03 |
| S13 | −3.4593E+00 | 1.5788E+00 | −7.8000E−01 | 3.7497E−01 | −1.5727E−01 | 4.8065E−02 | −5.9588E−03 |
| S14 | −8.1602E+00 | 2.1087E+00 | −6.5830E−01 | 2.6499E−01 | −1.3905E−01 | 7.6605E−02 | −3.7953E−02 |
| Surface number | A18 | A20 | A22 | A24 | A26 | A28 | A30 |
| S1 | −7.8353E−05 | −1.6384E−05 | 2.1960E−06 | 1.4255E−06 | 0.0000E+00 | 0.0000E+00 | 0.0000E+00 |
| S2 | 1.1113E−04 | 2.5284E−05 | 8.2975E−06 | −7.0785E−06 | −5.7952E−06 | 0.0000E+00 | 0.0000E+00 |
| S3 | 9.8667E−05 | 4.2753E−05 | 1.8150E−05 | 4.3834E−06 | 0.0000E+00 | 0.0000E+00 | 0.0000E+00 |
| S4 | −6.0177E−06 | 5.4300E−05 | 3.5003E−05 | 9.5635E−06 | 0.0000E+00 | 0.0000E+00 | 0.0000E+00 |
| S5 | −1.9984E−04 | −1.1107E−04 | −2.3687E−05 | −2.0656E−05 | −1.0067E−06 | 0.0000E+00 | 0.0000E+00 |
| S6 | 1.2893E−04 | −1.5258E−04 | 5.1635E−05 | −2.2650E−05 | 1.1857E−05 | 0.0000E+00 | 0.0000E+00 |
| S7 | 2.3110E−04 | −2.0588E−04 | 7.5697E−05 | −2.1042E−05 | 1.9498E−05 | 0.0000E+00 | 0.0000E+00 |
| S8 | −1.5309E−03 | −1.4216E−03 | −1.0128E−03 | −5.7950E−04 | −3.0210E−04 | −1.1291E−04 | −3.5266E−05 |
| S9 | −1.0915E−03 | −3.8306E−04 | −4.9755E−04 | 2.9095E−05 | 1.7018E−05 | 7.6242E−05 | −2.3906E−07 |
| S10 | 1.5377E−04 | 1.3325E−04 | −1.2880E−03 | 2.7266E−04 | 1.0872E−04 | 1.2723E−04 | −7.3300E−05 |
| S11 | −3.0517E−03 | −2.8700E−04 | −8.8514E−04 | 2.8411E−04 | −1.6442E−04 | 3.5076E−06 | −7.4998E−05 |
| S12 | −4.4227E−03 | 4.0691E−04 | −3.4180E−03 | −1.4904E−03 | 5.3665E−04 | 9.6772E−04 | 2.2103E−04 |
| S13 | −1.9801E−03 | −3.6352E−03 | 7.1247E−03 | −4.2067E−03 | 2.5696E−05 | 1.3598E−03 | −6.2536E−04 |
| S14 | 1.4953E−02 | −5.6648E−03 | 5.2814E−03 | −3.9516E−03 | 7.1962E−04 | −4.4179E−04 | 2.3945E−04 |

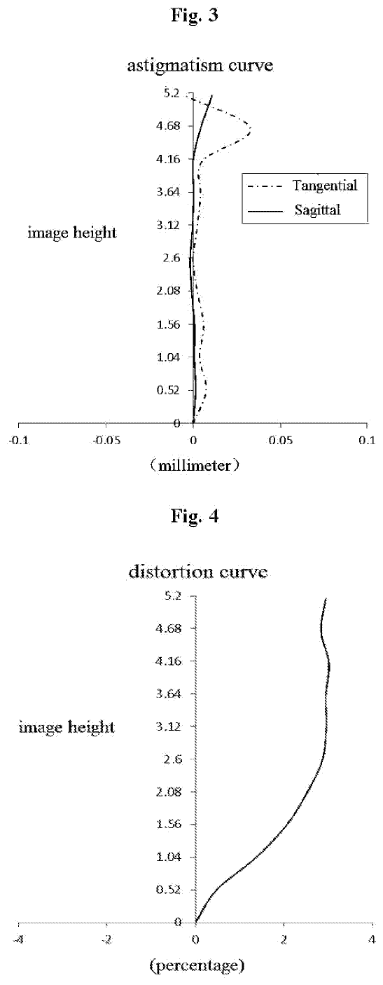

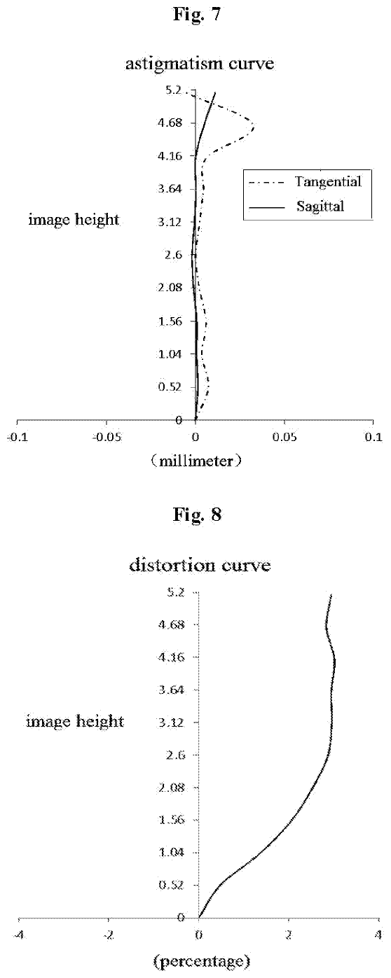

FIG. 2 shows a longitudinal aberration curve of the optical imaging lens assembly according to Example 1 at the maximum entrance pupil to represent deviations of a convergence focal point after light with different wavelengths passes through the optical imaging lens assembly. FIG. 3 shows an astigmatism curve of the optical imaging lens assembly according to Example 1 at the maximum entrance pupil to represent a tangential image surface curvature and a sagittal image surface curvature. FIG. 4 shows a distortion curve of the optical imaging lens assembly according to Example 1 at the maximum entrance pupil to represent distortion values corresponding to different fields of view. FIG. 6 shows a longitudinal aberration curve of the optical imaging lens assembly according to Example 1 at the minimum entrance pupil to represent deviations of a convergence focal point after light with different wavelengths passes through the optical imaging lens assembly. FIG. 7 shows an astigmatism curve of the optical imaging lens assembly according to Example 1 at the minimum entrance pupil to represent a tangential image surface curvature and a sagittal image surface curvature. FIG. 8 shows a distortion curve of the optical imaging lens assembly according to Example 1 at the minimum entrance pupil to represent distortion values corresponding to different fields of view.

According to FIGS. 2-4 and FIGS. 6-8, it can be seen that the optical imaging lens assembly provided in Example 1 may achieve high imaging quality.

### EXAMPLE 2

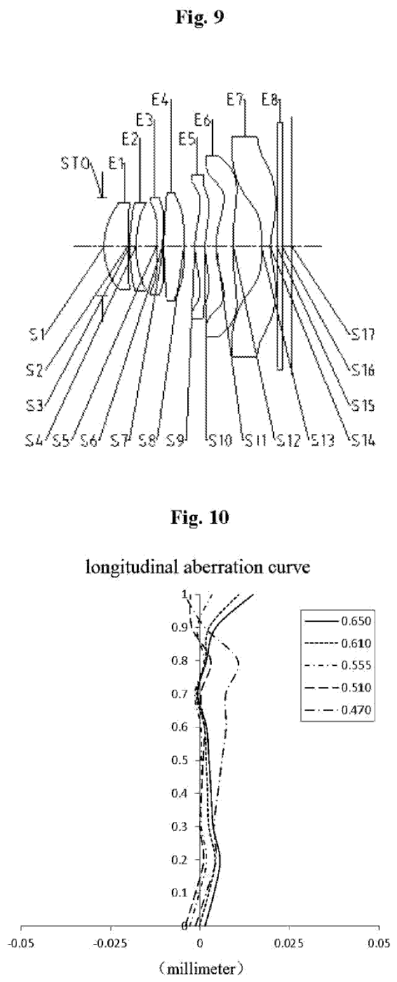

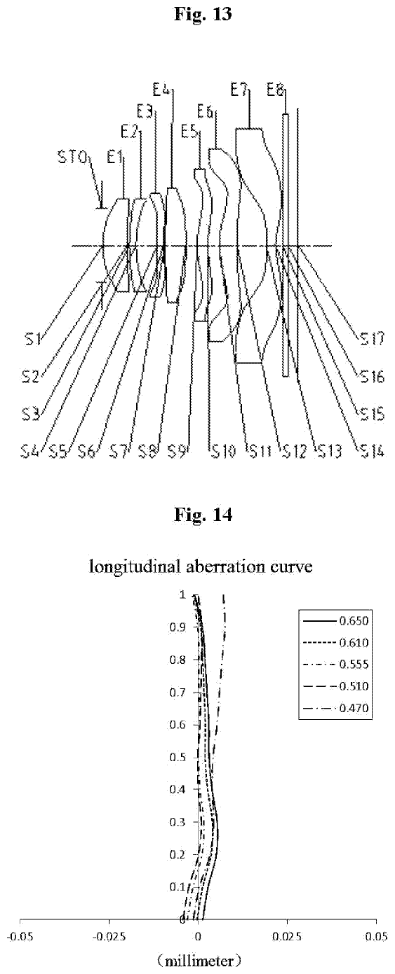

As shown in FIGS. 9-16, an optical imaging lens assembly according to Example 2 of the disclosure is described. Parts of descriptions similar to those in Example 2 are omitted in this example and the following examples for simplicity. FIG. 9 shows a structural schematic diagram of the optical imaging lens assembly at a maximum entrance pupil according to Example 2. FIG. 13 shows a structural schematic diagram of the optical imaging lens assembly at a minimum entrance pupil according to Example 2.

As shown in FIGS. 9 and 13, the optical imaging lens assembly sequentially includes from an object side to an image side: a variable diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a negative refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a concave surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a convex surface, and an image-side surface S14 of the seventh lens is a concave surface. The optical filter E8 has an object-side surface S15 of the optical filter and an image-side surface S16 of the optical filter. Light from an object sequentially penetrates through each of the surfaces S1 to S16, and is finally imaged on the imaging surface S17.

In the example, f is a total effective focal length of the optical imaging lens assembly, and f is 5.68 mm. FOV is a maximum field of view of the optical imaging lens assembly, and FOV is 41.5°. In the example, TTL is 7.42. FNO2 is an F-number corresponding to a minimum entrance pupil of the optical imaging lens assembly, and FNO2 is 2.06. FNO1 is an F-number corresponding to a maximum entrance pupil of the optical imaging lens assembly, and FNO1 is 1.46.

Table 3 shows a basic structural parameter table of the optical imaging lens assembly of Example 2, wherein the units of the curvature radius, the thickness/distance, and the focal length are all millimeters (mm).

TABLE 3

| | | | | Material | | |
|---|---|---|---|---|---|---|
| | | | | Refrac- | | Conic |
| Surface | Surface | Curvature | Thick- | tive | Abbe | coef- |
| number | type | radius | ness | index | number | ficient |
| OBJ | Spherical | Infinite | Infinite | | | |
| STO | Spherical | Infinite | 0.0400 | | | |
| S1 | Aspheric | 2.9467 | 0.9350 | 1.55 | 56.1 | 0.0051 |
| S2 | Aspheric | 14.3314 | 0.0758 | | | 12.7537 |
| S3 | Aspheric | 5.5862 | 0.2467 | 1.67 | 19.2 | −0.2100 |
| S4 | Aspheric | 3.7425 | 0.8062 | | | −0.0996 |
| S5 | Aspheric | 14.8703 | 0.2400 | 1.67 | 20.3 | 49.6169 |
| S6 | Aspheric | 5.4980 | 0.0479 | | | −1.2686 |
| S7 | Aspheric | 5.9924 | 0.8013 | 1.55 | 56.1 | −2.3374 |
| S8 | Aspheric | 83.3333 | 0.4293 | | | 78.9021 |
| S9 | Aspheric | 3.0631 | 0.4051 | 1.57 | 38.0 | 0.0786 |
| S10 | Aspheric | 3.1485 | 0.4361 | | | −0.0081 |
| S11 | Aspheric | 3.3493 | 0.6763 | 1.55 | 56.1 | −0.0006 |
| S12 | Aspheric | 55.8434 | 1.1082 | | | −26.3210 |
| S13 | Aspheric | 8.0811 | 0.3478 | 1.54 | 55.9 | −0.4142 |
| S14 | Aspheric | 1.7969 | 0.2639 | | | −1.0008 |
| S15 | Spherical | Infinite | 0.2100 | 1.52 | 64.2 | |
| S16 | Spherical | Infinite | 0.3935 | | | |
| S17 | Spherical | Infinite | | | | |

Table 4 shows high-order coefficients that may be used for each aspheric mirror surface in Example 2. A surface type of each aspheric surface may be defined by formula (1) given in the Example 1.

TABLE 4

| Surface number | A4 | A6 | A8 | A10 | A12 | A14 | A16 |
|---|---|---|---|---|---|---|---|
| S1 | −4.1949E−03 | −1.0325E−02 | −5.1768E−03 | −2.1244E−03 | −1.0317E−03 | −5.6462E−04 | −2.6573E−04 |
| S2 | −8.2356E−02 | 7.5239E−03 | −9.3266E−03 | −1.6313E−03 | −2.5472E−03 | −1.0815E−04 | 5.6384E−05 |
| S3 | −1.1297E−01 | 5.6779E−02 | −2.7023E−03 | −9.3511E−05 | −2.7190E−03 | −1.9856E−04 | 4.8927E−05 |
| S4 | −4.1098E−02 | 4.5016E−02 | 7.7650E−03 | 3.0944E−03 | −2.5395E−04 | −2.0905E−04 | −1.1952E−04 |
| S5 | −3.9288E−01 | −1.1064E−02 | 9.9763E−03 | 5.1073E−03 | −2.2047E−05 | −2.8414E−04 | −2.1950E−04 |
| S6 | −4.9768E−01 | 3.2365E−02 | 2.7568E−03 | 4.9538E−03 | −2.9636E−03 | −2.7967E−04 | −6.1447E−04 |
| S7 | −2.9157E−01 | 6.5607E−02 | −5.6870E−03 | 6.2667E−03 | −1.2096E−03 | 8.4020E−04 | −5.1098E−04 |
| S8 | −4.4802E−01 | 4.7146E−02 | 4.2530E−03 | 6.2077E−03 | 2.6257E−03 | 1.8506E−03 | 3.3813E−04 |
| S9 | −1.5367E+00 | 4.0838E−03 | −1.1858E−02 | 1.7458E−02 | −2.9344E−03 | 1.4922E−03 | −3.4277E−04 |
| S10 | −2.0727E+00 | 2.3166E−01 | −8.2278E−04 | 4.2479E−03 | −1.9737E−02 | 5.9560E−04 | 1.7663E−03 |
| S11 | −2.6337E+00 | −3.8405E−02 | 1.3573E−01 | 1.5178E−02 | −2.7442E−02 | −1.6142E−02 | 6.6591E−03 |
| S12 | −4.0423E−01 | −3.1081E−01 | 7.1925E−02 | −2.2453E−02 | 1.0801E−02 | −3.6407E−03 | 7.6684E−03 |
| S13 | −3.0892E+00 | 1.3402E+00 | −5.9500E−01 | 2.4319E−01 | −7.5873E−02 | 9.9011E−03 | −6.1380E−04 |
| S14 | −7.2633E+00 | 1.7404E+00 | −4.9738E−01 | 2.2483E−01 | −1.2847E−01 | 5.3488E−02 | −2.3105E−02 |
| Surface number | A18 | A20 | A22 | A24 | A26 | A28 | A30 |
| S1 | −9.2135E−05 | −1.3734E−05 | 4.0245E−06 | 1.8398E−06 | 0.0000E+00 | 0.0000E+00 | 0.0000E+00 |
| S2 | 1.8435E−04 | 3.0388E−05 | −3.9272E−06 | −1.6974E−05 | −9.1575E−06 | 0.0000E+00 | 0.0000E+00 |
| S3 | 2.0045E−04 | 6.7340E−05 | 1.7873E−05 | 1.4059E−06 | 0.0000E+00 | 0.0000E+00 | 0.0000E+00 |
| S4 | 2.2979E−05 | 5.3313E−05 | 3.5019E−05 | 1.1794E−05 | 0.0000E+00 | 0.0000E+00 | 0.0000E+00 |
| S5 | 3.4784E−05 | −3.8896E−06 | 2.8106E−05 | 3.4002E−06 | 7.4645E−06 | 0.0000E+00 | 0.0000E+00 |
| S6 | 1.1646E−04 | −1.3958E−04 | 4.7977E−05 | −4.3087E−06 | 6.1592E−06 | 0.0000E+00 | 0.0000E+00 |
| S7 | 1.6228E−04 | −1.6497E−04 | 7.5417E−05 | −8.7653E−06 | 2.5393E−07 | 0.0000E+00 | 0.0000E+00 |
| S8 | 5.8456E−05 | −5.8202E−06 | −4.8622E−05 | −1.4492E−05 | −1.6696E−05 | −9.5899E−07 | −3.9219E−06 |
| S9 | −1.3554E−03 | −4.8208E−04 | −2.9800E−04 | 1.1148E−04 | 5.8373E−05 | 9.1126E−05 | 2.9182E−05 |
| S10 | −9.3889E−04 | 5.8937E−04 | −2.0553E−04 | 1.7385E−04 | −1.0454E−04 | 7.1392E−05 | −3.1138E−05 |
| S11 | 3.7513E−04 | −8.5446E−04 | −2.3269E−04 | 5.1727E−04 | −9.7758E−05 | 2.8927E−05 | −5.4067E−05 |
| S12 | −2.4169E−03 | −1.1177E−04 | −4.2024E−04 | −8.2856E−04 | 2.0923E−04 | 5.5795E−04 | −1.2747E−04 |
| S13 | 6.4722E−03 | −8.7483E−03 | 4.6180E−03 | −1.0431E−05 | −1.3373E−03 | 2.9208E−04 | 2.0096E−04 |
| S14 | 1.3095E−02 | −8.4497E−03 | 5.6437E−03 | −9.1327E−04 | 7.2646E−04 | −1.0330E−03 | 1.3815E−04 |

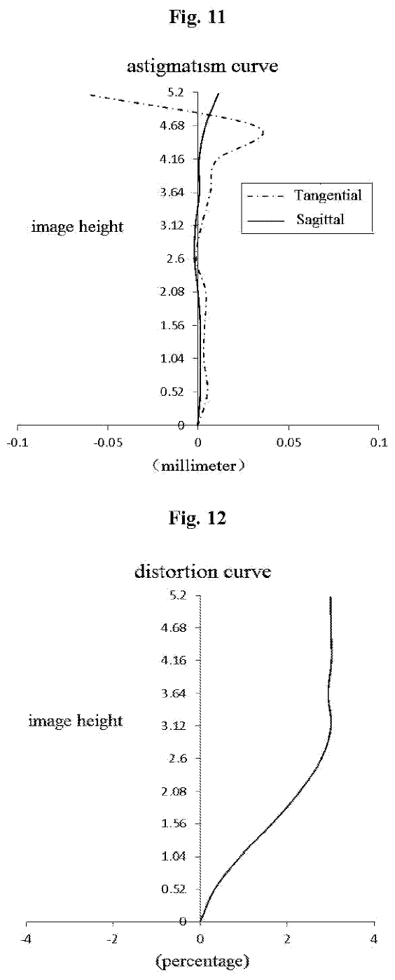

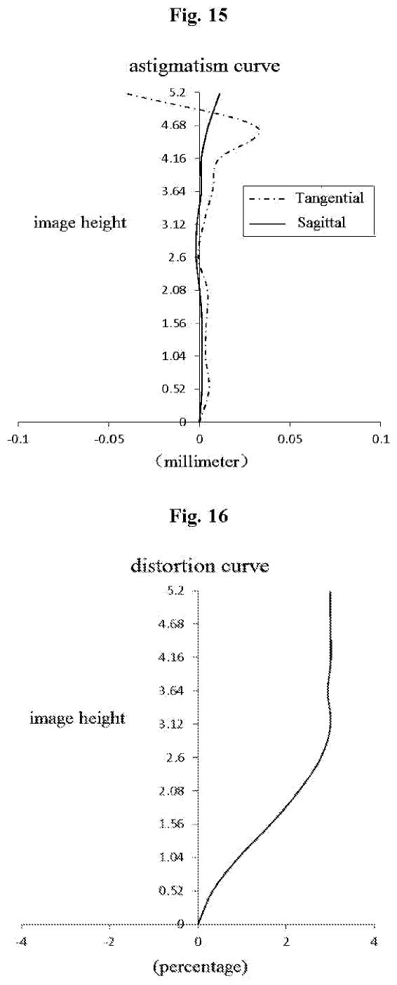

FIG. 10 shows a longitudinal aberration curve of the optical imaging lens assembly according to Example 2 at the maximum entrance pupil to represent deviations of a convergence focal point after light with different wavelengths passes through the optical imaging lens assembly. FIG. 11 shows an astigmatism curve of the optical imaging lens assembly according to Example 2 at the maximum entrance pupil to represent a tangential image surface curvature and a sagittal image surface curvature. FIG. 12 shows a distortion curve of the optical imaging lens assembly according to Example 2 at the maximum entrance pupil to represent distortion values corresponding to different fields of view. FIG. 14 shows a longitudinal aberration curve of the optical imaging lens assembly according to Example 2 at the minimum entrance pupil to represent deviations of a convergence focal point after light with different wavelengths passes through the optical imaging lens assembly. FIG. 15 shows an astigmatism curve of the optical imaging lens assembly according to Example 2 at the minimum entrance pupil to represent a tangential image surface curvature and a sagittal image surface curvature. FIG. 16 shows a distortion curve of the optical imaging lens assembly according to Example 2 at the minimum entrance pupil to represent distortion values corresponding to different fields of view.

According to FIGS. 10-12 and FIGS. 14-16, it can be seen that the optical imaging lens assembly provided in Example 2 may achieve high imaging quality.

### EXAMPLE 3

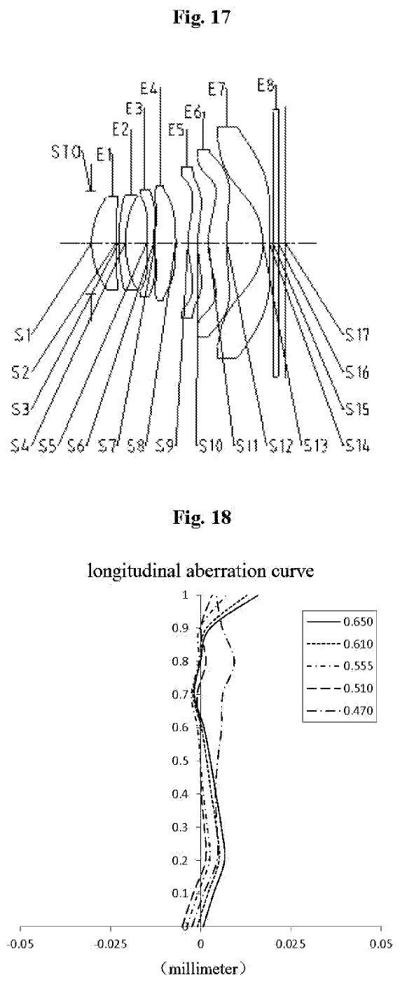

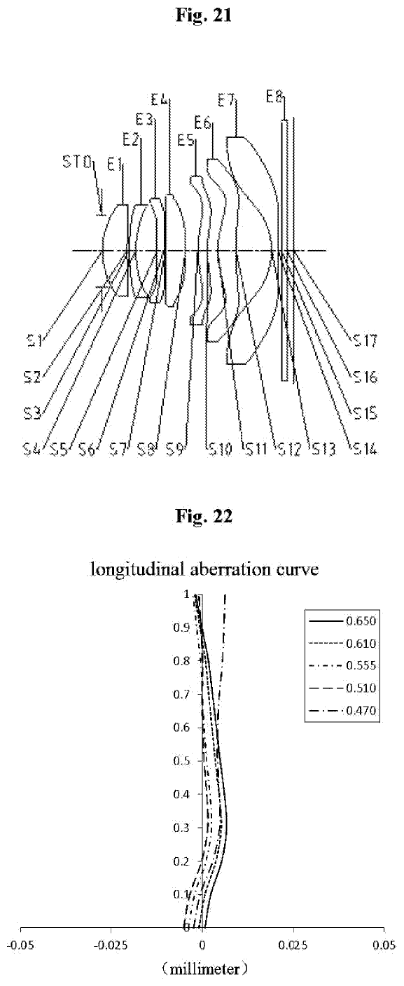

As shown in FIGS. 17-24, an optical imaging lens assembly according to Example 3 of the disclosure is described. Parts of descriptions similar to those in Example 3 are omitted in this example and the following examples for simplicity. FIG. 17 shows a structural schematic diagram of the optical imaging lens assembly at a maximum entrance pupil according to Example 3. FIG. 21 shows a structural schematic diagram of the optical imaging lens assembly at a minimum entrance pupil according to Example 3.

As shown in FIGS. 17 and 21, the optical imaging lens assembly sequentially includes from an object side to an image side: a variable diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a negative refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a convex surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a convex surface. The optical filter E8 has an object-side surface S15 of the optical filter and an image-side surface S16 of the optical filter. Light from an object sequentially penetrates through each of the surfaces S1 to S16, and is finally imaged on the imaging surface S17.

In the example, f is a total effective focal length of the optical imaging lens assembly, and f is 5.73 mm. FOV is a maximum field of view of the optical imaging lens assembly, and FOV is 41.5°. In the example, TTL is 7.46. FNO2 is an F-number corresponding to a minimum entrance pupil of the optical imaging lens assembly, and FNO2 is 2.08. FNO1 is an F-number corresponding to a maximum entrance pupil of the optical imaging lens assembly, and FNO1 is 1.47.

Table 5 shows a basic structural parameter table of the optical imaging lens assembly of Example 3, wherein the units of the curvature radius, the thickness/distance, and the focal length are all millimeters (mm).

TABLE 5

| | | | | Material | | |
|---|---|---|---|---|---|---|
| | | | | Refrac- | | Conic |
| Surface | Surface | Curvature | Thick- | tive | Abbe | coef- |
| number | type | radius | ness | index | number | ficient |
| OBJ | Spherical | Infinite | Infinite | | | |
| STO | Spherical | Infinite | 0.0400 | | | |
| S1 | Aspheric | 2.9829 | 0.9549 | 1.55 | 56.1 | −0.0147 |
| S2 | Aspheric | 19.4580 | 0.0817 | | | 25.2105 |
| S3 | Aspheric | 5.2833 | 0.2582 | 1.67 | 19.2 | −0.4882 |
| S4 | Aspheric | 3.4994 | 0.8318 | | | −0.1661 |
| S5 | Aspheric | 15.0327 | 0.2691 | 1.67 | 20.3 | 49.4907 |
| S6 | Aspheric | 5.7312 | 0.0598 | | | −0.9826 |
| S7 | Aspheric | 8.4822 | 0.7844 | 1.55 | 56.1 | −3.7736 |
| S8 | Aspheric | −24.2316 | 0.4732 | | | 59.8133 |
| S9 | Aspheric | 3.2004 | 0.3672 | 1.57 | 38.0 | −0.0181 |
| S10 | Aspheric | 3.1874 | 0.4126 | | | −0.0081 |
| S11 | Aspheric | 3.3598 | 0.7140 | 1.55 | 56.1 | −0.0044 |
| S12 | Aspheric | 31.1054 | 1.3879 | | | −26.3210 |
| S13 | Aspheric | −2.3231 | 0.2400 | 1.54 | 55.9 | −22.8750 |
| S14 | Aspheric | −66.6667 | 0.1428 | | | −99.0000 |
| S15 | Spherical | Infinite | 0.2100 | 1.52 | 64.2 | |
| S16 | Spherical | Infinite | 0.2723 | | | |
| S17 | Spherical | Infinite | | | | |

Table 6 shows high-order coefficients that may be used for each aspheric mirror surface in Example 3. A surface type of each aspheric surface may be defined by formula (1) given in Example 1.

TABLE 6

| Surface number | A4 | A6 | A8 | A10 | A12 | A14 | A16 |
|---|---|---|---|---|---|---|---|
| S1 | −8.8243E−03 | −1.2411E−02 | −5.8011E−03 | −2.3686E−03 | −1.1333E−03 | −5.9832E−04 | −3.0753E−04 |
| S3 | −7.6057E−02 | 1.4155E−03 | −8.5068E−03 | −1.4565E−03 | −2.0043E−03 | −2.6311E−04 | −1.2209E−04 |
| S4 | −1.1610E−01 | 4.6690E−02 | −2.3934 E−03 | 2.2313E−04 | −1.8568E−03 | −3.1034E−04 | −1.4104E−04 |
| S5 | −4.6208E−02 | 4.1128E−02 | 6.3295E−03 | 2.5270E−03 | −1.4591E−04 | −2.3277E−04 | −1.7882E−04 |
| S6 | −4.0529E−01 | −7.3534E−03 | 1.0333E−02 | 5.1847E−03 | 3.0863E−04 | −6.9449E−05 | −1.4531E−04 |
| S7 | −5.5490E−01 | 4.2152E−02 | 2.5543E−03 | 2.9581E−03 | −4.8882E−03 | −8.2641E−04 | −1.0478E−03 |
| S8 | −3.1018E−01 | 8.4959E−02 | −2.6809E−03 | 9.2770E−03 | −1.2096E−03 | 7.3631E−04 | −1.1429E−03 |
| S9 | −4.5509E−01 | 5.3645E−02 | 2.5044E−03 | 9.5324E−03 | 4.9116E−03 | 3.1222E−03 | 7.6934E−04 |
| S10 | −1.5050E+00 | 5.9606E−03 | −2.8222E−02 | 1.0437E−02 | −4.3554E−03 | 3.7947E−04 | 1.1873E−04 |
| S11 | −2.2636E+00 | 2.4266E−01 | −2.4862E−03 | −2.7955E−03 | −2.2768E−02 | 7.0818E−04 | 4.1131E−03 |
| S12 | −3.0326E+00 | 1.3492E−02 | 1.4057E−01 | −1.6999E−02 | −4.8150E−02 | −1.6118E−02 | 9.9942E−03 |
| S13 | −8.1691E−01 | −1.9567E−01 | 1.1908E−01 | −1.4954E−02 | 1.6800E−02 | 5.1197E−03 | 1.0767E−02 |
| S14 | −1.6190E+00 | 9.2615E−01 | −4.0272E−01 | 1.1667E−01 | −1.0795E−02 | −5.5514E−03 | −7.6937E−04 |
| Surface number | A18 | A20 | A22 | A24 | A26 | A28 | A30 |
| S1 | −1.3493E−04 | −6.2037E−05 | −2.4735E−05 | −1.0310E−05 | 0.0000E+00 | 0.0000E+00 | 0.0000E+00 |
| S3 | 3.8400E−05 | −1.3874E−05 | −1.3592E−05 | −7.8990E−06 | −8.7993E−07 | 0.0000E+00 | 0.0000E+00 |
| S4 | 1.1944E−05 | −1.1871E−05 | −1.0536E−05 | −4.6911E−06 | 0.0000E+00 | 0.0000E+00 | 0.0000E+00 |
| S5 | −6.8350E−05 | −1.7573E−05 | −3.7005E−06 | −7.2798E−07 | 0.0000E+00 | 0.0000E+00 | 0.0000E+00 |
| S6 | 5.5904E−05 | 2.2500E−05 | 2.2420E−05 | 1.0587E−05 | 2.8439E−06 | 0.0000E+00 | 0.0000E+00 |
| S7 | 3.7239E−05 | −4.4826E−05 | 3.4673E−05 | 2.6320E−05 | −3.1257E−06 | 0.0000E+00 | 0.0000E+00 |
| S8 | 1.0131E−04 | −4.5532E−05 | 5.3962E−05 | 2.9495E−05 | −1.8543E−05 | 0.0000E+00 | 0.0000E+00 |
| S9 | 1.4616E−04 | −6.9750E−05 | −9.4254E−05 | −6.4607E−05 | −3.7287E−05 | −1.1273E−05 | −4.5900E−06 |
| S10 | 1.5576E−04 | 1.3567E−04 | 8.0566E−05 | 8.3541E−05 | 5.8684E−05 | 4.6525E−05 | 1.7969E−05 |
| S11 | 5.2465E−04 | −5.0760E−04 | −4.6816E−04 | 4.1492E−05 | 8.9102E−05 | 3.3534E−05 | −4.0946E−05 |
| S12 | 1.0671E−03 | −2.7886E−03 | −4.9180E−04 | 2.1414E−04 | −1.4341E−04 | −1.0483E−04 | −6.9727E−05 |
| S13 | −5.1780E−04 | −1.6638E−03 | −8.3992E−04 | −1.9942E−03 | −4.7947E−04 | 4.1443E−04 | 1.8962E−04 |
| S14 | 4.4120E−03 | −4.0414E−03 | 1.5992E−03 | 2.5077E−04 | 4.5899E−04 | −1.1282E−03 | 3.3119E−04 |

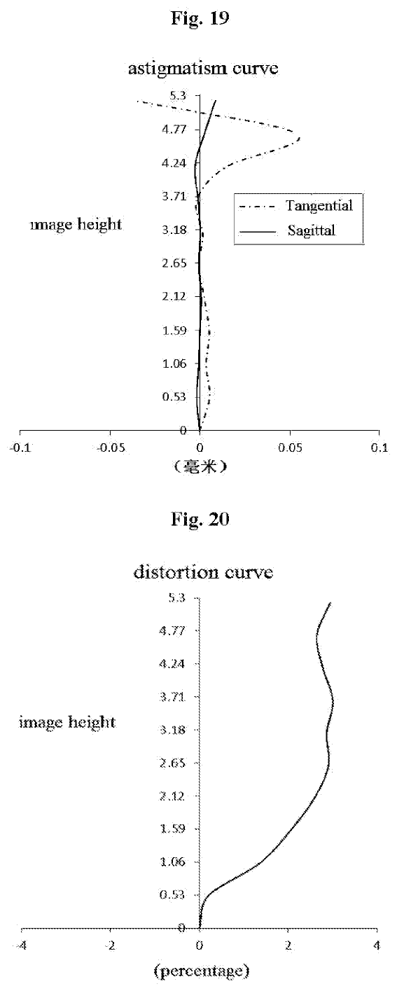

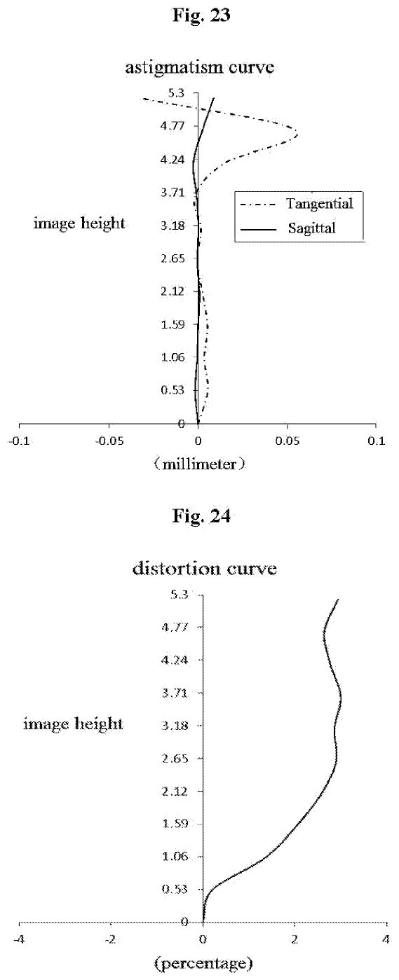

FIG. 18 shows a longitudinal aberration curve of the optical imaging lens assembly according to Example 3 at the maximum entrance pupil to represent deviations of a convergence focal point after light with different wavelengths passes through the optical imaging lens assembly. FIG. 19 shows an astigmatism curve of the optical imaging lens assembly according to Example 3 at the maximum entrance pupil to represent a tangential image surface curvature and a sagittal image surface curvature. FIG. 20 shows a distortion curve of the optical imaging lens assembly according to Example 3 at the maximum entrance pupil to represent distortion values corresponding to different fields of view. FIG. 22 shows a longitudinal aberration curve of the optical imaging lens assembly according to Example 3 at the minimum entrance pupil to represent deviations of a convergence focal point after light with different wavelengths passes through the optical imaging lens assembly. FIG. 23 shows an astigmatism curve of the optical imaging lens assembly according to Example 3 at the minimum entrance pupil to represent a tangential image surface curvature and a sagittal image surface curvature. FIG. 24 shows a distortion curve of the optical imaging lens assembly according to Example 3 at the minimum entrance pupil to represent distortion values corresponding to different fields of view.

According to FIGS. 18-20 and FIGS. 22-24, it can be seen that the optical imaging lens assembly provided in Example 3 may achieve high imaging quality.

### EXAMPLE 4

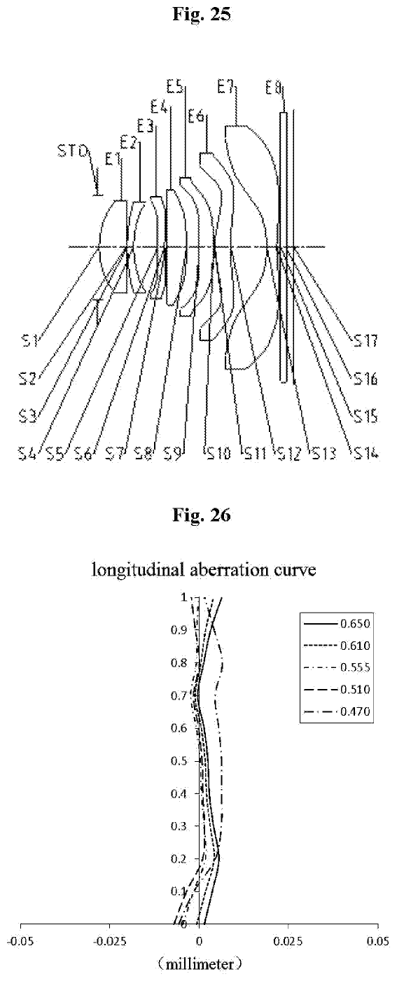

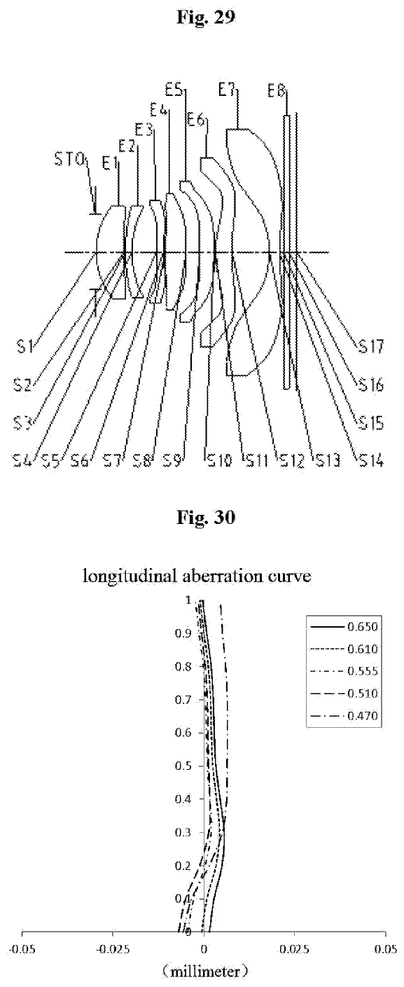

As shown in FIGS. 25-32, an optical imaging lens assembly according to Example 4 of the disclosure is described. Parts of descriptions similar to those in Example 4 are omitted in this example and the following examples for simplicity. FIG. 25 shows a structural schematic diagram of the optical imaging lens assembly at a maximum entrance pupil according to Example 4. FIG. 29 shows a structural schematic diagram of the optical imaging lens assembly at a minimum entrance pupil according to Example 4.

As shown in FIGS. 25 and 29, the optical imaging lens assembly sequentially includes from an object side to an image side: a variable diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a negative refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a convex surface. The fifth lens E5 has a negative refractive power, an object-side surface S9 of the fifth lens is a convex surface, and an image-side surface S10 of the fifth lens is a convex surface. The sixth lens E6 has a positive refractive power, an object-side surface S11 of the sixth lens is a convex surface, and an image-side surface S12 of the sixth lens is a concave surface. The seventh lens E7 has a negative refractive power, an object-side surface S13 of the seventh lens is a concave surface, and an image-side surface S14 of the seventh lens is a concave surface. The optical filter E8 has an object-side surface S15 of the optical filter and an image-side surface S16 of the optical filter. Light from an object sequentially penetrates through each of the surfaces S1 to S16, and is finally imaged on the imaging surface S17.

In the example, f is a total effective focal length of the optical imaging lens assembly, and f is 5.74 mm. FOV is a maximum field of view of the optical imaging lens assembly, and FOV is 41.2°. In the example, TTL is 7.47. FNO2 is an F-number corresponding to a minimum entrance pupil of the optical imaging lens assembly, and FNO2 is 2.08. FNO1 is an F-number corresponding to a maximum entrance pupil of the optical imaging lens assembly, and FNO1 is 1.47.

Table 7 shows a basic structural parameter table of the optical imaging lens assembly of Example 4, wherein the units of the curvature radius, the thickness/distance, and the focal length are all millimeters (mm).

TABLE 7

| | | | | Material | | |
|---|---|---|---|---|---|---|
| | | | | Refrac- | | Conic |
| Surface | Surface | Curvature | Thick- | tive | Abbe | coef- |
| number | type | radius | ness | index | number | ficient |
| OBJ | Spherical | Infinite | Infinite | | | |
| STO | Spherical | Infinite | 0.0400 | | | |
| S1 | Aspheric | 2.8448 | 1.0393 | 1.55 | 56.1 | 0.0463 |
| S2 | Aspheric | 19.2694 | 0.0400 | | | 35.4245 |
| S3 | Aspheric | 4.5891 | 0.2484 | 1.67 | 19.2 | −0.2331 |
| S4 | Aspheric | 3.2064 | 0.9225 | | | 0.1649 |
| S5 | Aspheric | 16.2487 | 0.2604 | 1.67 | 20.3 | 40.2440 |
| S6 | Aspheric | 5.6438 | 0.0650 | | | −0.9408 |
| S7 | Aspheric | 8.2394 | 0.7791 | 1.55 | 56.1 | −2.2294 |
| S8 | Aspheric | −38.9011 | 0.4962 | | | 99.0000 |
| S9 | Aspheric | 120.0000 | 0.5379 | 1.57 | 38.0 | 99.0000 |
| S10 | Aspheric | −80.0000 | 0.0489 | | | −0.0081 |
| S11 | Aspheric | 3.3913 | 0.6169 | 1.55 | 56.1 | −0.0106 |
| S12 | Aspheric | 29.4007 | 1.3823 | | | −26.3210 |
| S13 | Aspheric | −3.7138 | 0.3741 | 1.54 | 55.9 | −19.9325 |
| S14 | Aspheric | 6.3586 | 0.1600 | | | −88.2459 |
| S15 | Spherical | Infinite | 0.2100 | 1.52 | 64.2 | |
| S16 | Spherical | Infinite | 0.2891 | | | |
| S17 | Spherical | Infinite | | | | |

Table 8 shows high-order coefficients that may be used for each aspheric mirror surface in Example 4. A surface type of each aspheric surface may be defined by formula (1) given in Example 1.

TABLE 8

| Surface number | A4 | A6 | A8 | A10 | A12 | A14 | A16 |
|---|---|---|---|---|---|---|---|
| S1 | −1.3838E−03 | −1.1578E−02 | −6.6591E−03 | −3.0778E−03 | −1.3618E−03 | −5.8405E−04 | −2.3488E−04 |
| S3 | −7.3973E−02 | 1.0600E−03 | −1.3660E−02 | 3.9339E−04 | −2.2254E−03 | 6.3385E−04 | −2.9732E−04 |
| S4 | −1.1395E−01 | 4.8766E−02 | −7.1493E−03 | 1.8929E−03 | −1.7658E−03 | 6.1509E−04 | −9.2330E−05 |
| S5 | −3.5316E−02 | 4.4864E−02 | 5.7543E−03 | 2.4596E−03 | −2.0808E−05 | 4.3772E−05 | 1.2583E−05 |
| S6 | −3.9439E−01 | −7.4915E−03 | 1.0334E−02 | 3.4418E−03 | −1.6049E−04 | −2.4235E−04 | −6.0793E−05 |
| S7 | −4.9634E−01 | 2.8396E−02 | 7.0876E−03 | 2.6287E−03 | −2.4731E−03 | 3.2974E−05 | −1.9003E−04 |
| S8 | −2.7559E−01 | 6.8854E−02 | −7.4205E−03 | 2.0696E−03 | −1.2900E−03 | 1.1194E−03 | −1.5819E−04 |
| S9 | −4.9457E−01 | 6.5084E−02 | −5.4894E−03 | 1.4081E−03 | 1.7847E−03 | 1.8497E−03 | 4.5528E−04 |
| S10 | −7.0180E−01 | −2.9134E−02 | 2.4279E−03 | 5.5461E−03 | 1.1837E−04 | 1.0531E−03 | −8.8160E−05 |
| S11 | −1.0225E+00 | 1.5390E−01 | 3.2523E−02 | 1.5706E−02 | −6.0279E−03 | −7.5206E−03 | 1.6960E−04 |
| S12 | −2.4307E+00 | −7.8019E−02 | 6.7966E−02 | 2.8878E−02 | 1.7034E−03 | −1.8406E−02 | 4.1797E−03 |
| S13 | −7.9786E−01 | −2.0342E−01 | 1.4574E−01 | −4.1609E−02 | 1.1928E−02 | −1.0235E−02 | 1.3954E−02 |
| S14 | −1.3566E+00 | 7.7963E−01 | −3.4674E−01 | 1.0845E−01 | −5.9845E−03 | −1.0931E−02 | 3.8977E−03 |
| Surface number | A18 | A20 | A22 | A24 | A26 | A28 | A30 |
| S1 | −8.6530E−05 | −3.6863E−05 | −1.2976E−05 | −4.6253E−06 | 0.0000E+00 | 0.0000E+00 | 0.0000E+00 |
| S3 | 1.3369E−04 | −8.7395E−05 | 2.5694E−05 | −1.0679E−05 | 0.0000E+00 | 0.0000E+00 | 0.0000E+00 |
| S4 | 1.4515E−04 | −3.9040E−05 | 1.1610E−05 | 0.0000E+00 | 0.0000E+00 | 0.0000E+00 | 0.0000E+00 |
| S5 | 4.0986E−05 | 3.1616E−05 | 1.1274E−05 | 6.3558E−06 | 0.0000E+00 | 0.0000E+00 | 0.0000E+00 |
| S6 | 6.4655E−05 | 1.6164E−05 | 1.9800E−05 | 1.9121E−06 | 8.2476E−06 | 3.4554E−06 | 0.0000E+00 |
| S7 | 5.9183E−05 | −1.3194E−04 | 5.5600E−05 | −2.3988E−05 | 1.1414E−05 | 3.7204E−07 | 3.6626E−07 |
| S8 | 5.2309E−05 | −1.2220E−04 | 9.3950E−05 | −4.3840E−05 | 9.8274E−06 | −5.2916E−07 | 0.0000E+00 |
| S9 | 2.7906E−04 | 3.1784E−05 | 1.6027E−05 | −2.3983E−05 | −9.2903E−06 | −7.2325E−06 | −6.3627E−06 |
| S10 | 2.7732E−04 | −3.2914E−05 | 3.3560E−05 | −1.1236E−04 | −2.6972E−05 | −2.4075E−05 | −2.3032E−06 |
| S11 | −1.3451E−04 | 1.3005E−03 | 4.6041E−05 | −5.2086E−05 | −5.8313E−05 | −4.4815E−05 | 1.0322E−05 |
| S12 | 2.6998E−03 | 2.4157E−03 | −1.8499E−03 | −4.8804E−04 | −1.6404E−04 | 1.5845E−04 | 3.3945E−05 |
| S13 | −1.1686E−03 | −1.8362E−03 | −5.9631E−04 | 3.6525E−04 | −2.4243E−04 | −2.5039E−04 | 1.5649E−04 |
| S14 | 5.8718E−04 | 4.2435E−04 | −1.5970E−03 | 4.8629E−04 | −3.4760E−04 | 8.9426E−04 | −4.1554E−04 |

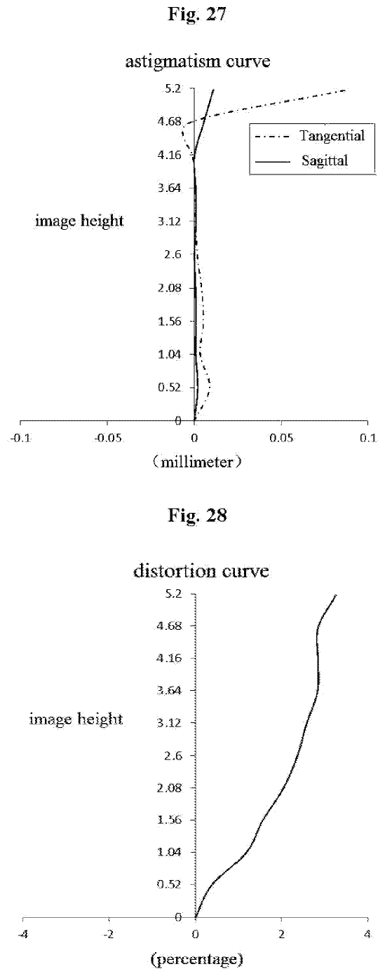

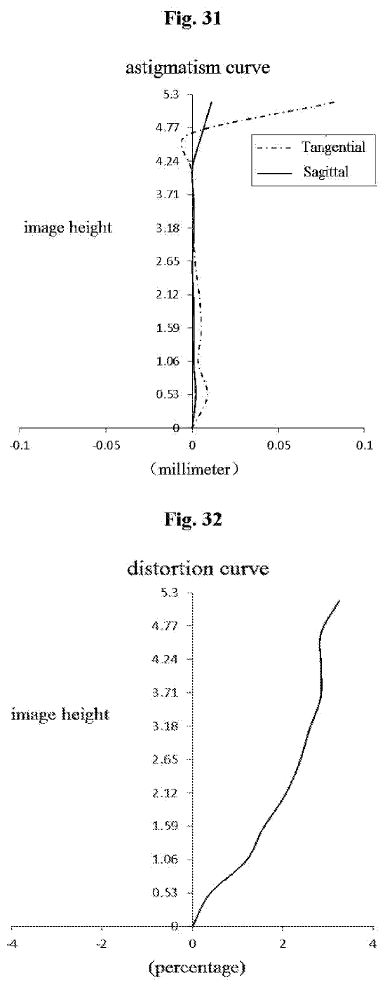

FIG. 26 shows a longitudinal aberration curve of the optical imaging lens assembly according to Example 4 at the maximum entrance pupil to represent deviations of a convergence focal point after light with different wavelengths passes through the optical imaging lens assembly. FIG. 27 shows an astigmatism curve of the optical imaging lens assembly according to Example 4 at the maximum entrance pupil to represent a tangential image surface curvature and a sagittal image surface curvature. FIG. 28 shows a distortion curve of the optical imaging lens assembly according to Example 4 at the maximum entrance pupil to represent distortion values corresponding to different fields of view. FIG. 30 shows a longitudinal aberration curve of the optical imaging lens assembly according to Example 4 at the minimum entrance pupil to represent deviations of a convergence focal point after light with different wavelengths passes through the optical imaging lens assembly. FIG. 31 shows an astigmatism curve of the optical imaging lens assembly according to Example 4 at the minimum entrance pupil to represent a tangential image surface curvature and a sagittal image surface curvature. FIG. 32 shows a distortion curve of the optical imaging lens assembly according to Example 4 at the minimum entrance pupil to represent distortion values corresponding to different fields of view.

According to FIGS. 26-28 and FIGS. 30-32, it can be seen that the optical imaging lens assembly provided in Example 4 may achieve high imaging quality.

### EXAMPLE 5

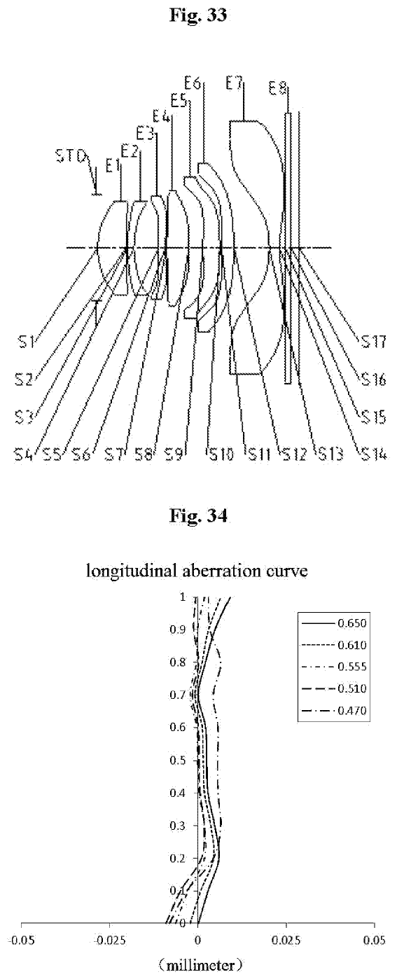

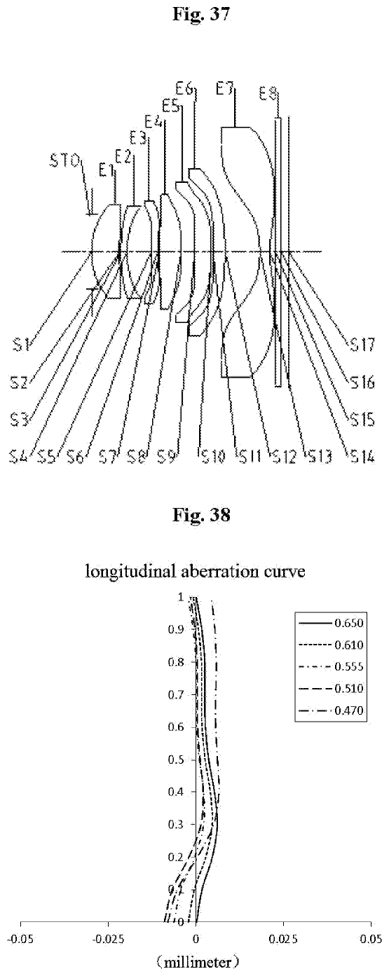

As shown in FIGS. 33-40, an optical imaging lens assembly according to Example 5 of the disclosure is described. Parts of descriptions similar to those in Example 5 are omitted in this example and the following examples for simplicity. FIG. 33 shows a structural schematic diagram of the optical imaging lens assembly at a maximum entrance pupil according to Example 5. FIG. 37 shows a structural schematic diagram of the optical imaging lens assembly at a minimum entrance pupil according to Example 5.

As shown in FIGS. 33 and 37, the optical imaging lens assembly sequentially includes from an object side to an image side: a variable diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a negative refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a convex surface, and an image-side surface S8 of the fourth lens is a convex surface. The fifth lens E5 has a negative refractive power, an object-side surface S9 of the fifth lens is a convex surface, and an image-side surface S10 of the fifth lens is a convex surface. The sixth lens E6 has a positive refractive power, an object-side surface S11 of the sixth lens is a concave surface, and an image-side surface S12 of the sixth lens is a convex surface. The seventh lens E7 has a negative refractive power, an object-side surface S13 of the seventh lens is a concave surface, and an image-side surface S14 of the seventh lens is a concave surface. The optical filter E8 has an object-side surface S15 of the optical filter and an image-side surface S16 of the optical filter. Light from an object sequentially penetrates through each of the surfaces S1 to S16, and is finally imaged on the imaging surface S17.

In the example, f is a total effective focal length of the optical imaging lens assembly, and f is 5.77 mm. FOV is a maximum field of view of the optical imaging lens assembly, and FOV is 41°. In the example, TTL is 7.46. FNO2 is an F-number corresponding to a minimum entrance pupil of the optical imaging lens assembly, and FNO2 is 2.06. FNO1 is an F-number corresponding to a maximum entrance pupil of the optical imaging lens assembly, and FNO1 is 1.46.

Table 9 shows a basic structural parameter table of the optical imaging lens assembly of Example 5, wherein the units of the curvature radius, the thickness/distance, and the focal length are all millimeters (mm).

TABLE 9

| | | | | Material | | |
|---|---|---|---|---|---|---|
| | | | | Refrac- | | Conic |
| Surface | Surface | Curvature | Thick- | tive | Abbe | coef- |
| number | type | radius | ness | index | number | ficient |
| OBJ | Spherical | Infinite | Infinite | | | |
| STO | Spherical | Infinite | −0.0191 | | | |
| S1 | Aspheric | 2.8263 | 1.0588 | 1.55 | 56.1 | 0.0369 |
| S2 | Aspheric | 20.7585 | 0.0400 | | | 42.0606 |
| S3 | Aspheric | 4.7897 | 0.2400 | 1.67 | 19.2 | −0.0588 |
| S4 | Aspheric | 3.2406 | 0.9153 | | | 0.2634 |
| S5 | Aspheric | 15.3475 | 0.2486 | 1.67 | 20.3 | 40.4695 |
| S6 | Aspheric | 5.4152 | 0.0566 | | | −1.7534 |
| S7 | Aspheric | 7.3290 | 0.8230 | 1.55 | 56.1 | −2.2162 |
| S8 | Aspheric | −42.2520 | 0.5105 | | | 98.5429 |
| S9 | Aspheric | 8.7433 | 0.6291 | 1.57 | 38.0 | −94.5034 |
| S10 | Aspheric | −28.8474 | 0.0634 | | | −0.0081 |
| S11 | Aspheric | −90.9091 | 0.4676 | 1.55 | 56.1 | −99.0000 |
| S12 | Aspheric | −6.0924 | 1.3081 | | | −26.3210 |
| S13 | Aspheric | −4.1357 | 0.3709 | 1.54 | 55.9 | −18.1727 |
| S14 | Aspheric | 4.5024 | 0.2181 | | | −29.4254 |
| S15 | Spherical | Infinite | 0.2100 | 1.52 | 64.2 | |
| S16 | Spherical | Infinite | 0.3000 | | | |
| S17 | Spherical | Infinite | | | | |

Table 10 shows high-order coefficients applied to each aspheric mirror surface in Example 5. A surface type of each aspheric surface may be defined by formula (1) given in Example 1.

TABLE 10

| Surface number | A4 | A6 | A8 | A10 | A12 | A14 | A16 |
|---|---|---|---|---|---|---|---|
| S1 | −4.9625E−03 | −1.2388E−02 | −6.7326E−03 | −3.0103E−03 | −1.3611E−03 | −6.0173E−04 | −2.3033E−04 |
| S3 | −7.1857E−02 | 2.2389E−03 | −1.2796E−02 | 1.0235E−04 | −2.2621E−03 | 6.9900E−04 | −1.6864E−04 |
| S4 | −1.1122E−01 | 4.9489E−02 | −7.1406E−03 | 1.1258E−03 | −2.0663E−03 | 6.2048E−04 | 4.3081E−05 |
| S5 | −2.9928E−02 | 4.5310E−02 | 5.9108E−03 | 2.1995E−03 | −2.8042E−04 | −5.9473E−05 | 2.0227E−05 |
| S6 | −3.9815E−01 | −7.6970E−03 | 1.1833E−02 | 4.2091E−03 | −5.9259E−05 | −3.3111E−04 | −6.3285E−05 |
| S7 | −5.1300E−01 | 2.8660E−02 | 7.9884E−03 | 2.1031E−03 | −2.0400E−03 | −2.7355E−04 | −3.1422E−04 |
| S8 | −2.8734E−01 | 8.0515E−02 | −7.7149E−03 | 1.7842E−03 | 2.3421E−04 | 8.9899E−04 | −3.8600E−04 |
| S9 | −5.2525E−01 | 7.5982E−02 | −2.8692E−03 | 3.6996E−03 | 3.8470E−03 | 2.4550E−03 | 5.1027E−04 |
| S10 | −8.3382E−01 | −2.0474E−02 | 3.9140E−03 | 6.5434E−03 | 2.4231E−03 | 1.6500E−03 | −5.8541E−04 |
| S11 | −9.9443E−01 | 1.8042E−01 | 5.0395E−02 | 7.9453E−03 | −1.7765E−02 | −1.1079E−02 | 1.1172E−03 |
| S12 | −8.5319E−01 | −7.1620E−02 | 5.0494E−02 | 1.3362E−02 | 1.0990E−02 | −1.1106E−02 | 1.6307E−04 |
| S13 | −4.6360E−01 | −6.9841E−02 | 4.2155E−02 | −2.2983E−02 | 1.5033E−02 | −5.5318E−03 | 3.6731E−03 |
| S14 | −1.2266E+00 | 8.0363E−01 | −3.4563E−01 | 8.4211E−02 | −4.0939E−03 | −8.0435E−03 | 5.2981E−03 |
| Surface number | A18 | A20 | A22 | A24 | A26 | A28 | A30 |
| S1 | −6.0484E−05 | −1.0167E−05 | 7.1731E−07 | −3.2246E−06 | 0.0000E+00 | 0.0000E+00 | 0.0000E+00 |
| S3 | 1.8855E−04 | −8.0454E−05 | 1.2094E−05 | −2.2701E−05 | 4.3542E−06 | 0.0000E+00 | 0.0000E+00 |
| S4 | 2.3972E−04 | 2.7483E−06 | 1.6433E−05 | −1.1807E−05 | −1.6948E−06 | 0.0000E+00 | 0.0000E+00 |
| S5 | 9.5344E−05 | 8.3747E−05 | 4.7540E−05 | 2.1210E−05 | 3.9938E−06 | 0.0000E+00 | 0.0000E+00 |
| S6 | 6.8902E−05 | 5.4220E−05 | 4.5626E−05 | 2.2248E−05 | 1.2465E−05 | 5.4865E−06 | 0.0000E+00 |
| S7 | −3.9319E−05 | −5.3932E−05 | 3.5204E−05 | −6.3025E−06 | −7.0870E−07 | 3.9638E−07 | −9.0674E−07 |
| S8 | 2.3737E−05 | −2.5613E−05 | 3.3939E−05 | −2.7836E−05 | 8.1284E−06 | 3.6355E−06 | 0.0000E+00 |
| S9 | 1.1803E−04 | −1.8533E−05 | −5.6899E−05 | −3.3024E−05 | −2.9268E−05 | −9.4500E−06 | −1.1683E−05 |
| S10 | −4.6364E−04 | −1.3008E−04 | −7.7641E−05 | 7.4283E−07 | 5.4518E−07 | 2.8397E−06 | 2.0240E−05 |
| S11 | 2.5186E−03 | 2.1364E−03 | −6.3531E−04 | −2.7984E−04 | −4.0918E−04 | 1.7476E−04 | 1.1779E−04 |
| S12 | −1.6891E−03 | 1.1594E−04 | −5.2738E−04 | 8.8839E−04 | 2.9275E−04 | 5.1219E−04 | 1.1799E−04 |
| S13 | −1.6433E−03 | −8.9270E−04 | 4.0302E−04 | 6.2798E−04 | −5.1232E−05 | −1.0238E−04 | −6.4941E−05 |
| S14 | 2.1155E−03 | 1.4660E−03 | −4.4846E−03 | 2.6144E−04 | 5.5473E−04 | 1.1223E−03 | −6.7045E−04 |

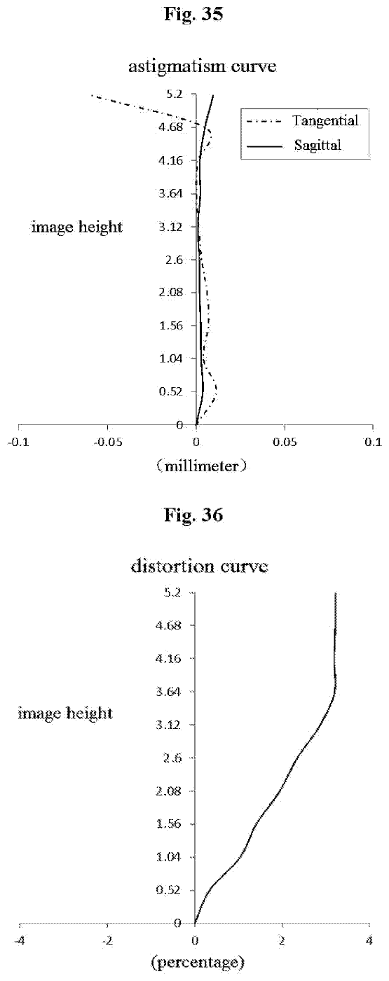

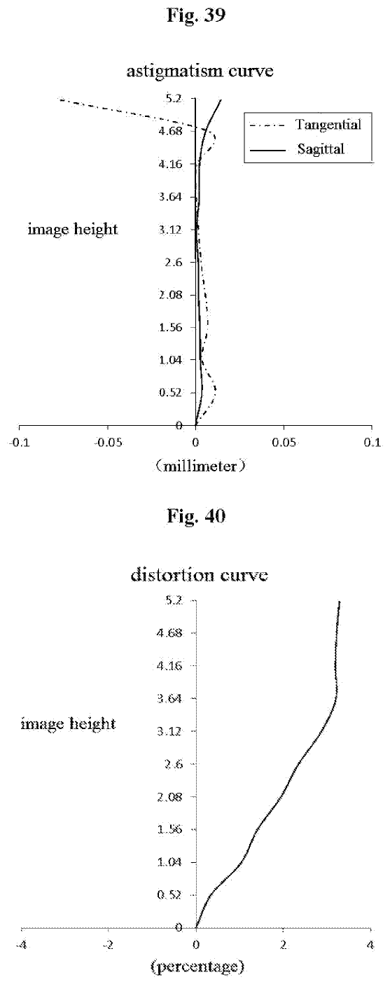

FIG. 34 shows a longitudinal aberration curve of the optical imaging lens assembly according to Example 5 at the maximum entrance pupil to represent deviations of a convergence focal point after light with different wavelengths passes through the optical imaging lens assembly. FIG. 35 shows an astigmatism curve of the optical imaging lens assembly according to Example 5 at the maximum entrance pupil to represent a tangential image surface curvature and a sagittal image surface curvature. FIG. 36 shows a distortion curve of the optical imaging lens assembly according to Example 5 at the maximum entrance pupil to represent distortion values corresponding to different fields of view. FIG. 38 shows a longitudinal aberration curve of the optical imaging lens assembly according to Example 5 at the minimum entrance pupil to represent deviations of a convergence focal point after light with different wavelengths passes through the optical imaging lens assembly. FIG. 39 shows an astigmatism curve of the optical imaging lens assembly according to Example 5 at the minimum entrance pupil to represent a tangential image surface curvature and a sagittal image surface curvature. FIG. 40 shows a distortion curve of the optical imaging lens assembly according to Example 5 at the minimum entrance pupil to represent distortion values corresponding to different fields of view.

According to FIGS. 34-36 and FIGS. 38-40, it can be seen that the optical imaging lens assembly provided in Example 5 may achieve high imaging quality.

### EXAMPLE 6

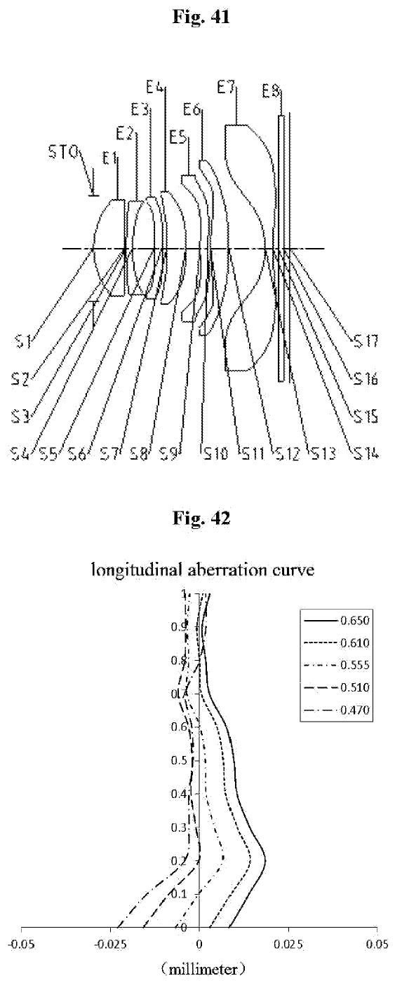

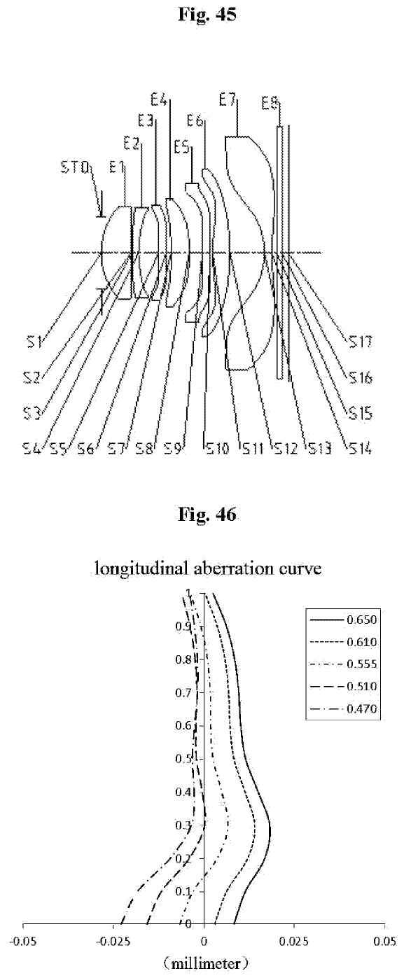

As shown in FIGS. 41-48, an optical imaging lens assembly according to Example 6 of the disclosure is described. Parts of descriptions similar to those in Example 6 are omitted in this example and the following examples for simplicity. FIG. 41 shows a structural schematic diagram of the optical imaging lens assembly at a maximum entrance pupil according to Example 6. FIG. 45 shows a structural schematic diagram of the optical imaging lens assembly at a minimum entrance pupil according to Example 6.

As shown in FIGS. 41 and 45, the optical imaging lens assembly sequentially includes from an object side to an image side: a variable diaphragm STO, a first lens E1, a second lens E2, a third lens E3, a fourth lens E4, a fifth lens E5, a sixth lens E6, a seventh lens E7, an optical filter E8 and an imaging surface S17.

The first lens E1 has a negative refractive power, an object-side surface S1 of the first lens is a convex surface, and an image-side surface S2 of the first lens is a concave surface. The second lens E2 has a positive refractive power, an object-side surface S3 of the second lens is a convex surface, and an image-side surface S4 of the second lens is a concave surface. The third lens E3 has a positive refractive power, an object-side surface S5 of the third lens is a convex surface, and an image-side surface S6 of the third lens is a concave surface. The fourth lens E4 has a positive refractive power, an object-side surface S7 of the fourth lens is a concave surface, and an image-side surface S8 of the fourth lens is a convex surface. The fifth lens E5 has a negative refractive power, an object-side surface S9 of the fifth lens is a convex surface, and an image-side surface S10 of the fifth lens is a concave surface. The sixth lens E6 has a positive refractive power, an object-side surface S11 of the sixth lens is a convex surface, and an image-side surface S12 of the sixth lens is a convex surface. The seventh lens E7 has a negative refractive power, an object-side surface S13 of the seventh lens is a concave surface, and an image-side surface S14 of the seventh lens is a concave surface. The optical filter E8 has an object-side surface S15 of the optical filter and an image-side surface S16 of the optical filter. Light from an object sequentially penetrates through each of the surfaces S1 to S16, and is finally imaged on the imaging surface S17.

In the example, f is a total effective focal length of the optical imaging lens assembly, and f is 5.78 mm. FOV is a maximum field of view of the optical imaging lens assembly, and FOV is 40.5°. In the example, TTL is 7.386. FNO2 is an F-number corresponding to a minimum entrance pupil of the optical imaging lens assembly, and FNO2 is 2.07. FNO1 is an F-number corresponding to a maximum entrance pupil of the optical imaging lens assembly, and FNO1 is 1.46.

Table 11 shows a basic structural parameter table of the optical imaging lens assembly of Example 6, wherein the units of the curvature radius, the thickness/distance, and the focal length are all millimeters (mm).

TABLE 11

| | | | | Material | | |
|---|---|---|---|---|---|---|
| | | | | Refrac- | | Conic |
| Surface | Surface | Curvature | Thick- | tive | Abbe | coef- |
| number | type | radius | ness | index | number | ficient |
| OBJ | Spherical | Infinite | Infinite | | | |
| STO | Spherical | Infinite | 0.0021 | | | |
| S1 | Aspheric | 2.8142 | 1.1736 | 1.55 | 56.1 | 0.0541 |
| S2 | Aspheric | 50.5824 | 0.0551 | | | 75.4237 |
| S3 | Aspheric | 8.4121 | 0.2400 | 1.67 | 19.2 | 0.6479 |
| S4 | Aspheric | 4.0456 | 0.8012 | | | 0.1084 |
| S5 | Aspheric | 18.2119 | 0.3025 | 1.67 | 20.3 | 45.0161 |
| S6 | Aspheric | 21.1296 | 0.1839 | | | 76.5687 |
| S7 | Aspheric | −75.7576 | 0.7101 | 1.55 | 56.1 | −98.9235 |
| S8 | Aspheric | −21.5864 | 0.5301 | | | 94.2440 |
| S9 | Aspheric | 8.0776 | 0.3015 | 1.57 | 38.0 | −83.8922 |
| S10 | Aspheric | 11.1440 | 0.0975 | | | −0.0081 |
| S11 | Aspheric | 9.2424 | 0.6814 | 1.55 | 56.1 | 0.0000 |
| S12 | Aspheric | −6.8015 | 1.3675 | | | −26.3210 |
| S13 | Aspheric | −2.8543 | 0.2765 | 1.54 | 55.9 | −13.8861 |
| S14 | Aspheric | 5.9325 | 0.2056 | | | −45.6303 |
| S15 | Spherical | Infinite | 0.2100 | 1.52 | 64.2 | |
| S16 | Spherical | Infinite | 0.2448 | | | |
| S17 | Spherical | Infinite | | | | |

Table 12 shows high-order coefficients applied to each aspheric mirror surface in Example 6. A surface type of each aspheric surface may be defined by formula (1) given in Example 1.

TABLE 12

| Surface number | A4 | A6 | A8 | A10 | A12 | A14 | A16 |
|---|---|---|---|---|---|---|---|
| S1 | −2.0841E−03 | −1.5276E−02 | −1.0025E−02 | −4.7359E−03 | −2.0435E−03 | −8.3857E−04 | −3.2476E−04 |
| S3 | −6.5729E−02 | −3.7843E−03 | −1.6623E−02 | 3.9002E−04 | −2.3895E−03 | 1.0162E−03 | −1.9693E−04 |
| S4 | −1.0950E−01 | 5.6203E−02 | −9.6469E−03 | 3.1649E−03 | −2.4914E−03 | 9.7769E−04 | −7.3589E−05 |
| S5 | −3.0639E−02 | 5.0396E−02 | 4.5415E−03 | 3.4355E−03 | −5.1399E−04 | 3.1627E−05 | −1.1674E−04 |
| S6 | −3.6697E−01 | −1.8186E−02 | 1.0517E−02 | 5.0414E−03 | −1.8305E−04 | −5.4616E−04 | −4.0056E−04 |
| S7 | −3.6466E−01 | 4.3336E−03 | 9.4589E−03 | 3.9208E−03 | −1.9398E−04 | −3.5194E−04 | −5.4676E−04 |
| S8 | −2.2448E−01 | 4.4863E−02 | −7.3861E−03 | 1.9355E−03 | 2.5609E−03 | 8.0114E−04 | −3.4865E−04 |
| S9 | −5.4528E−01 | 5.8595E−02 | −8.2282E−03 | 1.8740E−03 | 3.5900E−03 | 3.0555E−03 | 8.6741E−04 |
| S10 | −8.0639E−01 | −3.4663E−03 | −9.7760E−03 | 7.1660E−03 | 1.2545E−03 | 2.5972E−03 | −1.1402E−03 |
| S11 | −9.7590E−01 | 1.1256E−01 | 4.5251E−02 | 1.1301E−02 | −8.4892E−03 | −6.8032E−03 | 1.7452E−04 |
| S12 | −9.0405E−01 | −7.8049E−02 | 7.2349E−02 | 3.2108E−03 | 1.1699E−02 | −1.4183E−02 | 2.0630E−03 |
| S13 | −3.3470E−01 | −4.5036E−02 | 5.9247E−03 | −2.4369E−02 | 1.7720E−02 | −1.3016E−02 | −3.2253E−05 |
| S14 | −1.1128E+00 | 8.0180E−01 | −3.5582E−01 | 9.4052E−02 | −3.1947E−03 | −1.1036E−02 | 9.7421E−04 |
| Surface number | A18 | A20 | A22 | A24 | A26 | A28 | A30 |
| S1 | −1.0910E−04 | −3.5314E−05 | −8.4064E−06 | −4.8421E−06 | 0.0000E+00 | 0.0000E+00 | 0.0000E+00 |
| S3 | 1.3611E−04 | −8.3114E−05 | 2.5179E−05 | −8.7444E−06 | 1.1086E−05 | 0.0000E+00 | 0.0000E+00 |
| S4 | 1.9782E−04 | −3.3030E−05 | 1.7038E−05 | −3.6101E−06 | 8.6562E−06 | 0.0000E+00 | 0.0000E+00 |
| S5 | 3.2548E−05 | 2.6788E−05 | 2.6467E−05 | 5.7328E−06 | 2.6255E−06 | 0.0000E+00 | 0.0000E+00 |
| S6 | 5.5010E−05 | −3.5950E−05 | 2.0336E−05 | −2.2224E−05 | 3.8525E−06 | −4.3434E−06 | 0.0000E+00 |
| S7 | 1.6528E−04 | −7.7786E−05 | 1.5200E−05 | −2.7049E−05 | 8.4332E−06 | 5.2988E−06 | −1.4000E−06 |
| S8 | 2.7497E−04 | −1.0842E−04 | −4.6458E−05 | −1.8741E−05 | 4.6747E−06 | 8.2078E−06 | −1.5334E−06 |
| S9 | 5.9749E−04 | 2.3801E−04 | 7.2210E−05 | 2.8540E−05 | −2.3035E−05 | −7.4782E−06 | −1.7397E−05 |
| S10 | −4.9608E−04 | −4.3338E−05 | −1.9216E−04 | 1.6354E−04 | −2.7988E−05 | 5.8710E−05 | 2.0394E−05 |
| S11 | 4.8447E−04 | 9.9647E−04 | −2.8273E−04 | 7.4462E−05 | −3.2430E−04 | 2.2892E−04 | −4.4459E−05 |
| S12 | −2.7541E−03 | 4.8371E−04 | 8.0222E−05 | 2.7837E−04 | −9.0792E−05 | 2.5734E−04 | −8.1270E−05 |
| S13 | −1.6795E−03 | 1.3404E−04 | 5.2655E−04 | −5.7025E−04 | −2.4142E−04 | 3.1533E−04 | 1.8520E−04 |
| S14 | 3.6802E−03 | −6.7254E−04 | −3.4166E−03 | 9.6512E−04 | 1.7379E−03 | −7.6590E−04 | −2.0666E−04 |

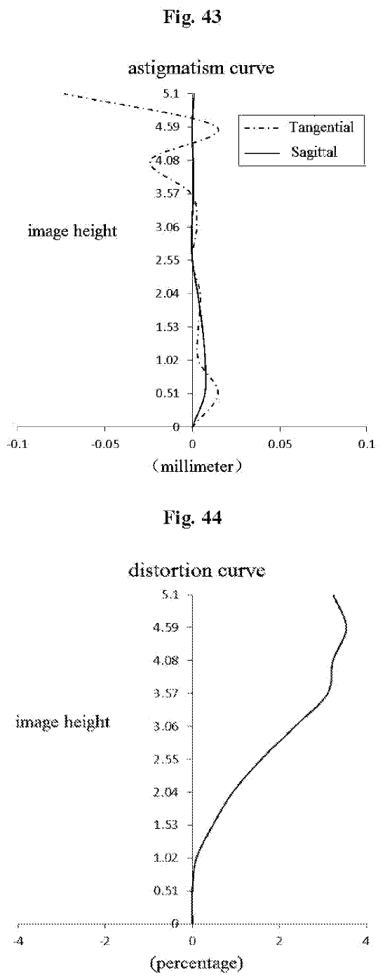

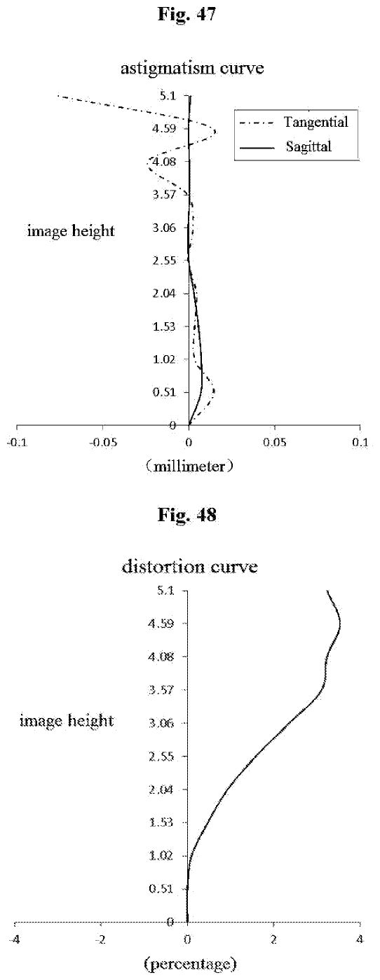

FIG. 42 shows a longitudinal aberration curve of the optical imaging lens assembly according to Example 6 at the maximum entrance pupil to represent deviations of a convergence focal point after light with different wavelengths passes through the optical imaging lens assembly. FIG. 43 shows an astigmatism curve of the optical imaging lens assembly according to Example 6 at the maximum entrance pupil to represent a tangential image surface curvature and a sagittal image surface curvature. FIG. 44 shows a distortion curve of the optical imaging lens assembly according to Example 6 at the maximum entrance pupil to represent distortion values corresponding to different fields of view. FIG. 46 shows a longitudinal aberration curve of the optical imaging lens assembly according to Example 6 at the minimum entrance pupil to represent deviations of a convergence focal point after light with different wavelengths passes through the optical imaging lens assembly. FIG. 47 shows an astigmatism curve of the optical imaging lens assembly according to Example 6 at the minimum entrance pupil to represent a tangential image surface curvature and a sagittal image surface curvature. FIG. 48 shows a distortion curve of the optical imaging lens assembly according to Example 6 at the minimum entrance pupil to represent distortion values corresponding to different fields of view.

According to FIGS. 42-44 and FIGS. 46-48, it can be seen that the optical imaging lens assembly provided in Example 6 may achieve high imaging quality.

From the above, Example 1 to Example 6 satisfy a relationship shown in Table 13 respectively.

TABLE 13

| | embodiment | | | | | |
|---|---|---|---|---|---|---|
| Conditional expression | 1 | 2 | 3 | 4 | 5 | 6 |
| CT1/T67 | 0.95 | 0.84 | 0.69 | 0.75 | 0.81 | 0.86 |
| T1/FNO1 | 0.68 | 0.70 | 0.67 | 0.74 | 0.75 | 0.81 |
| f/ΔEPD | 4.97 | 4.99 | 5.02 | 5.03 | 4.98 | 4.99 |
| TTL/ImgH | 1.43 | 1.43 | 1.43 | 1.44 | 1.44 | 1.45 |
| f56/f1234 | 0.72 | 0.71 | 0.81 | 0.79 | 0.77 | 0.86 |
| f*tan(Semi-FOV) (mm) | 5.01 | 5.03 | 5.07 | 5.02 | 5.02 | 4.94 |
| CT4/T23 | 0.96 | 0.99 | 0.94 | 0.84 | 0.90 | 0.89 |
| SAG61/SAG62 | 0.73 | 0.69 | 0.60 | 0.79 | 0.91 | 0.48 |
| SAG72/SAG71 | 0.34 | 0.46 | 0.72 | 0.72 | 0.50 | 0.58 |
| f6/(f7 − f2) | 0.42 | 0.49 | 0.58 | 0.55 | 1.01 | 0.89 |
| f1/(R2 − R1) | 0.59 | 0.58 | 0.38 | 0.36 | 0.33 | 0.11 |
| (R3 + R4)/(R5 + R6) | 0.37 | 0.46 | 0.42 | 0.36 | 0.39 | 0.32 |
| EPD1*tan(Semi-FOV) (mm) | 2.44 | 2.44 | 2.44 | 2.41 | 2.43 | 2.39 |

Table 14 shows the effective focal lengths f, effective focal lengths f1 to f7 of each lens, and the maximum fields of view FOV of the optical imaging lens assembly in Example 1 to Example 6.

TABLE 14

| Example | | | | | | |
|---|---|---|---|---|---|---|
| parameter | 1 | 2 | 3 | 4 | 5 | 6 |
| f1 (mm) | 6.54 | 6.61 | 6.33 | 5.99 | 5.88 | 5.42 |
| f2 (mm) | −18.49 | −17.71 | −16.26 | −16.95 | −15.79 | −11.77 |
| f3 (mm) | −13.15 | −13.22 | −14.06 | −13.10 | −12.68 | 190.00 |
| f4 (mm) | 10.98 | 11.80 | 11.62 | 12.54 | 11.52 | 55.12 |
| f5 (mm) | 140.08 | 72.79 | 148.82 | 84.31 | 11.85 | 49.74 |
| f6 (mm) | 5.94 | 6.51 | 6.85 | 6.97 | 11.95 | 7.30 |
| f7 (mm) | −4.22 | −4.39 | −4.49 | −4.31 | −3.96 | −3.55 |
| f (mm) | 5.66 | 5.68 | 5.73 | 5.74 | 5.77 | 5.78 |
| TTL (mm) | 7.39 | 7.42 | 7.46 | 7.47 | 7.46 | 7.38 |
| ImgH (mm) | 5.16 | 5.18 | 5.22 | 5.18 | 5.19 | 5.10 |
| Semi-FOV(°) | 41.5 | 41.5 | 41.5 | 41.2 | 41.0 | 40.5 |
| FNO1 | 1.45 | 1.46 | 1.47 | 1.47 | 1.46 | 1.46 |
| FNO2 | 2.05 | 2.06 | 2.08 | 2.08 | 2.06 | 2.07 |

The disclosure also provides an imaging device, of which an electronic photosensitive element may be a Charge Coupled Device (CCD) or a Complementary Metal Oxide Semiconductor (CMOS). The imaging device may be an independent imaging device such as a digital camera, or may be an imaging module integrated into a mobile electronic device such as a mobile phone. The imaging device is provided with the above-mentioned optical imaging lens assembly.

It is apparent that the described embodiments are not all but only part of embodiments of the disclosure. All other embodiments obtained by those of ordinary skill in the art based on the embodiments in the disclosure without creative work shall fall within the scope of protection of the disclosure.

It is to be noted that terms used herein are only adopted to describe specific implementation modes and not intended to limit exemplary implementation modes according to the disclosure. For example, singular forms, used herein, are also intended to include plural forms, unless otherwise clearly pointed out. In addition, it is also to be understood that terms “contain” and/or “include” used in the specification refer/refers to existence of features, steps, work, apparatuses, components and/or combinations thereof.

It is to be noted that terms “first”, “second” and the like in the specification, claims and drawings of the disclosure are adopted not to describe a specific sequence or order but to distinguish similar objects. It is to be understood that data used like this may be exchanged under a proper condition for embodiments, described herein, of the disclosure in sequences besides those shown or described here.

The above are only the specific embodiments of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

What is claimed is:

1. An optical imaging lens assembly, sequentially comprising from an object side to an image side along an optical axis:
a variable diaphragm;
a first lens;
a second lens;
a third lens;
a fourth lens;
a fifth lens, an object-side surface thereof is a convex surface;
a sixth lens; and
a seventh lens,
wherein a center thickness CT1 of the first lens on the optical axis and an air space T67 between the sixth lens and the seventh lens on the optical axis satisfy CT1/T67<1.0; and
T1 is a distance from the variable diaphragm corresponding to a maximum entrance pupil of the optical imaging lens assembly to an image-side surface of the first lens on the optical axis, FNO1 is an F-number corresponding to the maximum entrance pupil of the optical imaging lens assembly, and T1 and FNO1 satisfy 0.5<T1/FNO1<1.0.

2. The optical imaging lens assembly according to claim 1, wherein ΔEPD is a difference between a maximum entrance pupil diameter of the optical imaging lens assembly and a minimum entrance pupil diameter of the optical imaging lens assembly, and ΔEPD and an effective focal length f of the optical imaging lens assembly satisfy f/ΔEPD<5.5.

3. The optical imaging lens assembly according to claim 1, wherein TTL is a distance from an object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.5.

4. The optical imaging lens assembly according to claim 1, wherein EPD1 is a maximum entrance pupil diameter of the optical imaging lens assembly, Semi-FOV is a half of a maximum field of view of the optical imaging lens assembly, and EPD1 and Semi-FOV satisfy EPD1*tan(Semi-FOV)<3.0 mm.

5. The optical imaging lens assembly according to claim 1, wherein f1234 is a combined focal length of the first lens, the second lens, the third lens and the fourth lens, f56 is a combined focal length of the fifth lens and the sixth lens, and f1234 and f56 satisfy 0.5<f56/f1234<1.0.

6. The optical imaging lens assembly according to claim 1, wherein Semi-FOV is a half of a maximum field of view of the optical imaging lens assembly, and Semi-FOV and an effective focal length f of the optical imaging lens assembly satisfy f*tan(Semi-FOV)>4.5 mm.

7. The optical imaging lens assembly according to claim 1, wherein a center thickness CT4 of the fourth lens on the optical axis and an air space T23 between the second lens and the third lens on the optical axis satisfy 0.5<CT4/T23<1.0.

8. The optical imaging lens assembly according to claim 1, wherein SAG61 is an on-axis distance from an intersection point of an object-side surface of the sixth lens and the optical axis to an effective radius vertex of the object-side surface of the sixth lens, SAG62 is an on-axis distance from an intersection point of an image-side surface of the sixth lens and the optical axis to an effective radius vertex of the image-side surface of the sixth lens, and SAG61 and SAG62 satisfy 0<SAG61/SAG62<1.0.

9. The optical imaging lens assembly according to claim 1, wherein SAG71 is an on-axis distance from an intersection point of an object-side surface of the seventh lens and the optical axis to an effective radius vertex of the object-side surface of the seventh lens, SAG72 is an on-axis distance from an intersection point of an image-side surface of the seventh lens and the optical axis to an effective radius vertex of the image-side surface of the seventh lens, and SAG71 and SAG72 satisfy 0<SAG72/SAG71<1.0.

10. The optical imaging lens assembly according to claim 1, wherein an effective focal length f2 of the second lens, an effective focal length f6 of the sixth lens and an effective focal length f7 of the seventh lens satisfy 0.3<f6/(f7−f2)<1.3

11. The optical imaging lens assembly according to claim 1, wherein an effective focal length f1 of the first lens, a curvature radius R1 of an object-side surface of the first lens and a curvature radius R2 of an image-side surface of the first lens satisfy 0<f1/(R2−R1)<1.0.

12. The optical imaging lens assembly according to claim 1, wherein a curvature radius R3 of an object-side surface of the second lens, a curvature radius R4 of an image-side surface of the second lens, a curvature radius R5 of an object-side surface of the third lens and a curvature radius R6 of an image-side surface of the third lens satisfy 0<(R3+R4)/(R5+R6)<1.0.

13. The optical imaging lens assembly according to claim 1, wherein
the second lens has a negative refractive power;
an image-side surface of the third lens is a concave surface;
the fourth lens has a positive refractive power;
the fifth lens has a positive refractive power;
the sixth lens has a positive refractive power.

14. An optical imaging lens assembly, sequentially comprising from an object side to an image side along an optical axis:
a variable diaphragm;
a first lens;
a second lens;
a third lens;
a fourth lens;
a fifth lens, an object-side surface thereof is a convex surface;
a sixth lens; and
a seventh lens,
wherein a center thickness CT1 of the first lens on the optical axis and an air space T67 between the sixth lens and the seventh lens on the optical axis satisfy CT1/T67<1.0; and
EPD1 is a maximum entrance pupil diameter of the optical imaging lens assembly, Semi-FOV is a half of a maximum field of view of the optical imaging lens assembly, and EPD1 and Semi-FOV satisfy EPD1×tan(Semi-FOV)<3.0 mm.

15. The optical imaging lens assembly according to claim 14, wherein ΔEPD is a difference between a maximum entrance pupil diameter of the optical imaging lens assembly and a minimum entrance pupil diameter of the optical imaging lens assembly, and ΔEPD and an effective focal length f of the optical imaging lens assembly satisfy f/ΔEPD<5.5.

16. The optical imaging lens assembly according to claim 14, wherein TTL is a distance from an object-side surface of the first lens to an imaging surface of the optical imaging lens assembly on the optical axis, ImgH is a half of a diagonal length of an effective pixel region on the imaging surface, and TTL and ImgH satisfy TTL/ImgH<1.5.

17. The optical imaging lens assembly according to claim 14, wherein f1234 is a combined focal length of the first lens, the second lens, the third lens and the fourth lens, f56 is a combined focal length of the fifth lens and the sixth lens, and f1234 and f56 satisfy 0.5<f56/f1234<1.0.

18. The optical imaging lens assembly according to claim 14, wherein Semi-FOV is a half of a maximum field of view of the optical imaging lens assembly, and Semi-FOV and an effective focal length f of the optical imaging lens assembly satisfy f*tan(Semi-FOV)>4.5 mm.

19. The optical imaging lens assembly according to claim 14, wherein a center thickness CT4 of the fourth lens on the optical axis and an air space T23 between the second lens and the third lens on the optical axis satisfy 0.5<CT4/T23<1.0.

20. The optical imaging lens assembly according to claim 14, wherein SAG61 is an on-axis distance from an intersection point of an object-side surface of the sixth lens and the optical axis to an effective radius vertex of the object-side surface of the sixth lens, SAG62 is an on-axis distance from an intersection point of an image-side surface of the sixth lens and the optical axis to an effective radius vertex of the image-side surface of the sixth lens, and SAG61 and SAG62 satisfy 0<SAG61/SAG62<1.0.
